(19) United States
(12) Patent Application Publication
(10) Pub. No.: US 2007/0233838 A1
(43) Pub. Date: Oct. 4, 2007

(54) Method for workload management of plural servers

(75) Inventors: Yoshifumi Takamoto, Kokubunji (JP); Takao Nakajima, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/495,037

(22) Filed: Jul. 28, 2006

(30) Foreign Application Priority Data
Mar. 30, 2006 (JP) 2006-093401

(51) Int. Cl. G06F 15/173

(52) U.S. Cl. 709/223; 709/226

(57) ABSTRACT

An object of this invention is to facilitate the workload management of a virtual server by an administrator in environment that a plurality of virtual computers configuring a single or a plurality of task systems are distributed among a plurality of physical computers. To achieve the object, there is provided a computer management method based upon a computer management method in a computer system having a plurality of physical computers, a plurality of virtual computers operated in the physical computer and a management computer connected to the physical computer via a network and characterized in that specification for performance allocated every group is accepted, the performance of the physical computers is acquired and the performance of the specified group is allocated to the virtual computers included in the group based upon the acquired performance of the physical computers.

### CLAIM OF PRIORITY

The present application claims priority from Japanese patent application 2006-93401 filed on Mar. 30, 2006, the content of which is hereby incorporated by reference into this application.

### BACKGROUND OF THE INVENTION

The present invention relates to a computer management method, particularly relates to a method of managing the workload of a plurality of computers.

The number of possessed servers increases in a corporate computer system and in a corporate data center. As a result, the management cost of the servers increases.

To solve the problem, technique for virtualizing a server is used. The technique for virtualizing a server means technique for enabling a plurality of virtual servers to operate as a single physical server. Specifically, resources such as a processor (CPU) and a memory provided to the physical server are split and the split resources of the physical server are allocated to a plurality of virtual servers. The plural virtual servers are simultaneously operated in the single physical server.

Today, as the performance of CPU is enhanced and the cost of a resource such as a memory is reduced, demand for the technique for virtualizing a server increases.

In addition to a merit that according to the technique for virtualizing a server, the plurality of virtual servers can be operated in the single physical server, resources of the physical server can be more effectively utilized by managing a workload by the plurality of virtual servers.

Workload management means changing the volume of resources of the physical server allocated to the virtual servers according to a situation such as a load of the physical server. For example, when a load of the certain virtual server is increased, the resource of the physical server allocated to the virtual server which is operated in the same physical server and a load of which is light is allocated to the virtual server having a heavy load. Hereby, the resources of the physical server can be effectively utilized.

JP 2004-334853 A, JP 2004-252988 A and JP 2003-157177 A discloses the workload management executed between/among virtual servers operated in a single physical server.

### SUMMARY OF THE INVENTION

In environment in which a plurality of virtual servers are operated in a plurality of physical servers, each virtual server rarely performs an independent and completely different task. For example, a task system for processing a single tank is configured by a plurality of virtual servers such as a group of web servers, a group of application servers and a group of database servers. In this case, the plurality of virtual servers configuring the single task system are distributed among the plurality of physical servers. A case that a plurality of task systems mingle in the plurality of physical servers is also conceivable.

In conventional type workload management, it is difficult to manage a workload of a plurality of virtual servers in system environment where a plurality of physical servers are installed.

That is, when the plurality of virtual servers configuring a task system are distributed among the plurality of physical servers, an administrator is required to manage the workload of each physical server in consideration of correspondence between the virtual server configuring the task system and the physical server and the performance of CPU in each physical server in the conventional type workload management. Therefore, it is difficult to frequently change an amount of resources of the physical server allocated to the virtual server.

An object of this invention is to facilitate the workload management of virtual servers by an administrator in environment in which a plurality of virtual servers configuring a single or a plurality of task systems are distributed among a plurality of physical server.

According to a representative aspect of this invention, this invention is based upon a computer management method in a computer system having a plurality of physical computers each of which is equipped with a processor for operation, a memory connected to the processor and an interface connected to the memory, a plurality of virtual computers operated in the physical computer and a management computer equipped with a processor connected to the physical computer via a network for operation, a memory connected to the processor and an interface connected to the memory, and is characterized in that the management computer stores information for relating the physical computer and the virtual computer operated in the physical computer and information for managing one or a plurality of virtual computers as a group, accepts specification for performance allocated every group, acquires the performance of the physical computers and allocates the specified performance of the group to the virtual computers included in the group based upon the acquired performance of the physical computers.

According to representative embodiment of this invention, as the performance of a physical server is allocated to a virtual server in units of group acquired by grouping a plurality of virtual servers, workload management is facilitated for an administrator.

### BRIEF DESCRIPTION OF THE DRAWINGS

The present invention can be appreciated by the description which follows in conjunction with the following figures, wherein:

FIG. 1 shows a computer system equivalent to a first embodiment of this invention;

FIG. 2 is a block diagram showing a physical server in the first embodiment of this invention;

FIG. 3 shows workload management in the first embodiment of this invention;

FIG. 4 shows group management for virtual servers in the first embodiment of this invention;

FIG. 5 shows the definition of system groups in the first embodiment of this invention;

FIG. 6 shows a server group allocation setting command in the first embodiment of this invention;

FIG. 7 shows a server configuration table in the first embodiment of this invention;

FIG. 8 shows a group definition table in the first embodiment of this invention;

FIG. 9 shows the configuration of a history management program in the first embodiment of this invention;

FIG. 10 shows a physical CPU utilization factor history in the first embodiment of this invention;

FIG. 11 shows a virtual CPU utilization factor history in the first embodiment of this invention;

FIG. 12 shows the configuration of a workload management program in the first embodiment of this invention;

FIG. 13 is a flowchart showing a process by a command processing module in the first embodiment of this invention;

FIG. 14 is a flowchart showing a process by a workload calculating module in the first embodiment of this invention;

FIG. 15 is a flowchart showing a process for allocating equally in the first embodiment of this invention;

FIG. 16 shows equal allocation in the first embodiment of this invention;

FIG. 17 is a flowchart showing a process for allocating to a functional group equally in the first embodiment of this invention;

FIG. 18 is a flowchart showing a process for allocating based upon a functional group history in the first embodiment of this invention;

FIG. 19 is a flowchart showing a process by a workload switching module in the first embodiment of this invention;

FIG. 20 is a flowchart showing a process by a load balancer control module in the first embodiment of this invention;

FIG. 21 shows a screen displayed when a server group is added in the first embodiment of this invention;

FIG. 22 shows a screen displayed when a system group is added in the first embodiment of this invention;

FIG. 23 shows a screen displayed when a functional group is added in the first embodiment of this invention;

FIG. 24 shows a screen displayed when the definition of a group is changed in the first embodiment of this invention;

FIG. 25 shows a screen displayed when the group definition change is executed in the first embodiment of this invention;

FIG. 26 shows a server configuration table in a second embodiment of this invention; and

FIG. 27 shows a server group allocation setting command in the second embodiment of this invention.

### DETAILED DESCRIPTION OF THE PREFERRED EMBODIMENTS

### First Embodiment

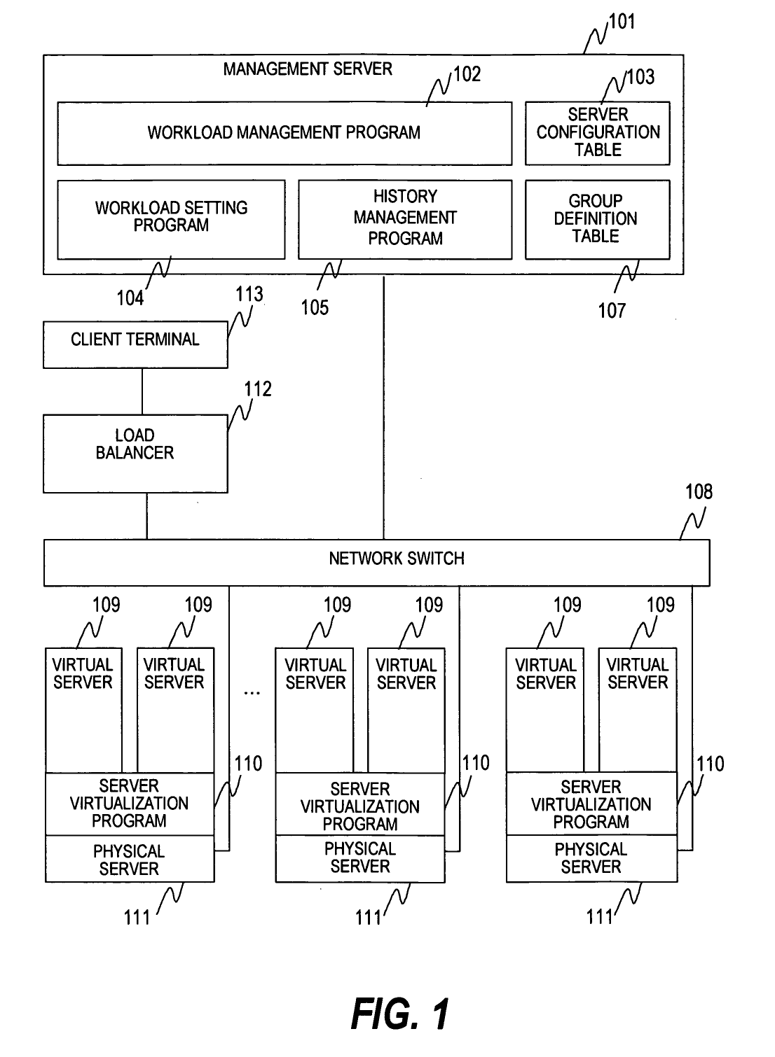

FIG. 1 shows the configuration of a computer system equivalent to a first embodiment of this invention.

The computer system equivalent to this embodiment comprises a management server 101, physical servers 111, a load balancer 112 and a client terminal 113.

The management server 101, the physical servers 111 and the load balancer 112 are connected by a network switch 108 via a network 206. Further, the client terminal 113 is connected to the network switch 108 via the load balancer 112.

It is the management server 101 that functions as the center of control in this embodiment. The management server 101 comprises CPU that executes various programs and a memory. The management server 101 also comprises a display not shown and a console formed by a keyboard. When the management server 101 does not have the console, a computer connected to the management server 101 via the network may also have the console. The management server 101 stores a workload management program 102, a workload setting program 104, a history management program 105, a server configuration table 103 and a group definition table 107.

The management server 101 controls the physical servers 111, server virtualization programs 110, virtual servers 109 and the load balancer 112.

A plurality of virtual servers 109 are constructed in one physical server 111 by the server virtualization program 110. The server virtualization program 110 may be also application software for constructing the virtual servers 109 operated by a hypervisor or an operating system for example.

The load balancer 112 distributes a request to the plurality of virtual servers 109 when the load balancer receives the request transmitted from the client terminal 113.

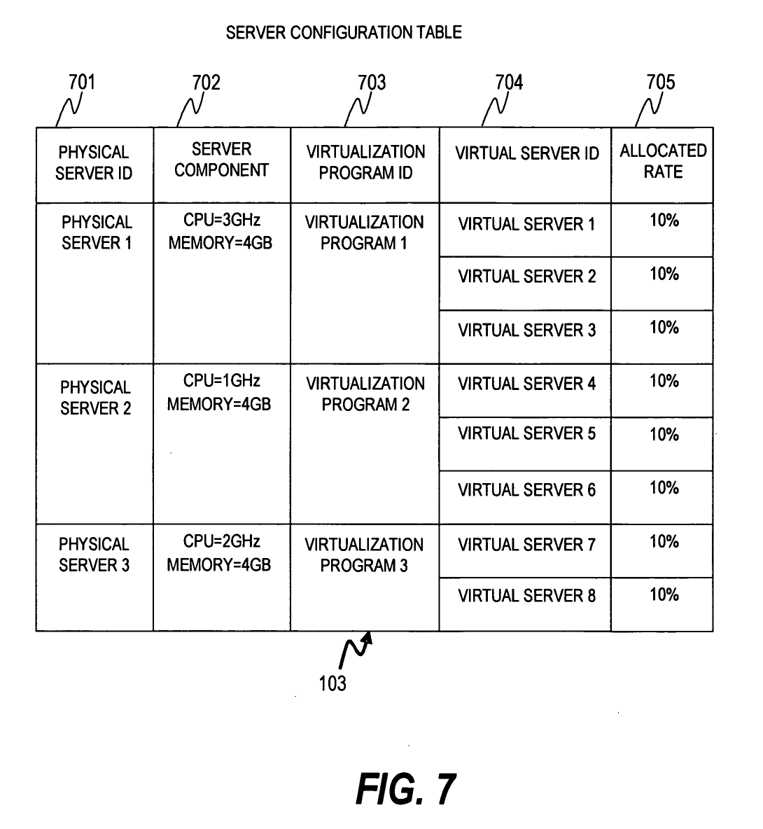

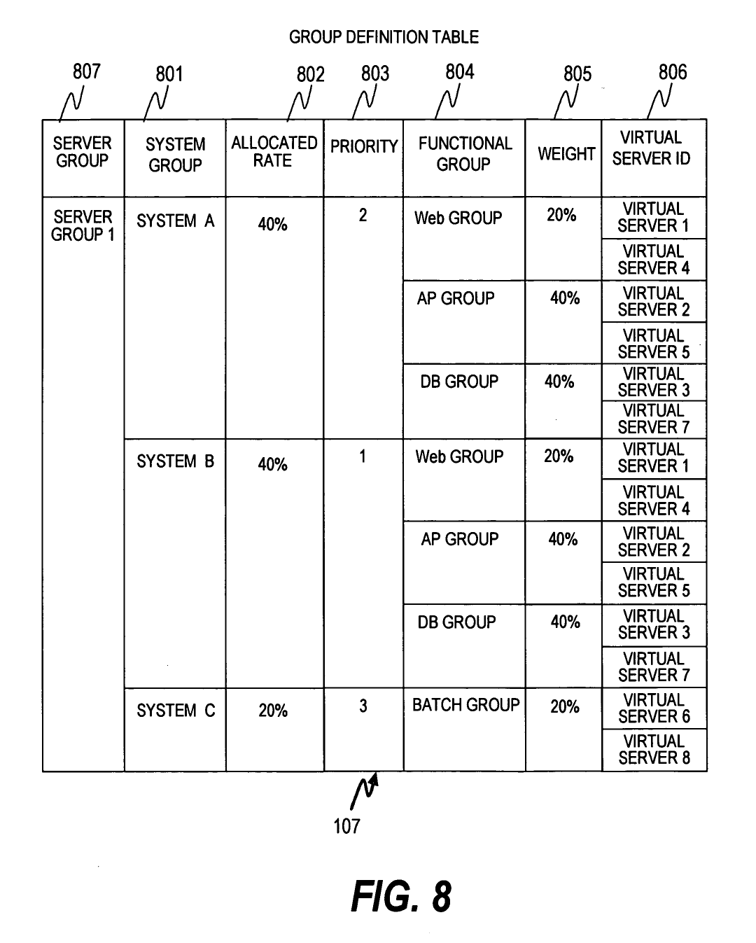

The workload management program 102 determines each rate (a workload) of resources of CPU 202 and others of the physical server 111 allocated to the plurality of virtual servers 109. The workload setting program 104 manages the workload by instructing the server virtualization program 110 to actually allocate the resources of the physical server 111 to the plurality of virtual servers 109 according to the allocated rate determined by the workload management program 102. The server configuration table 103 manages correspondence between the physical server 111 and the virtual server 109 as described in relation to FIG. 7 later. The group definition table 107 manages each rate allocated to the plurality of virtual servers 109 in units of group as described in relation to FIG. 8 later.

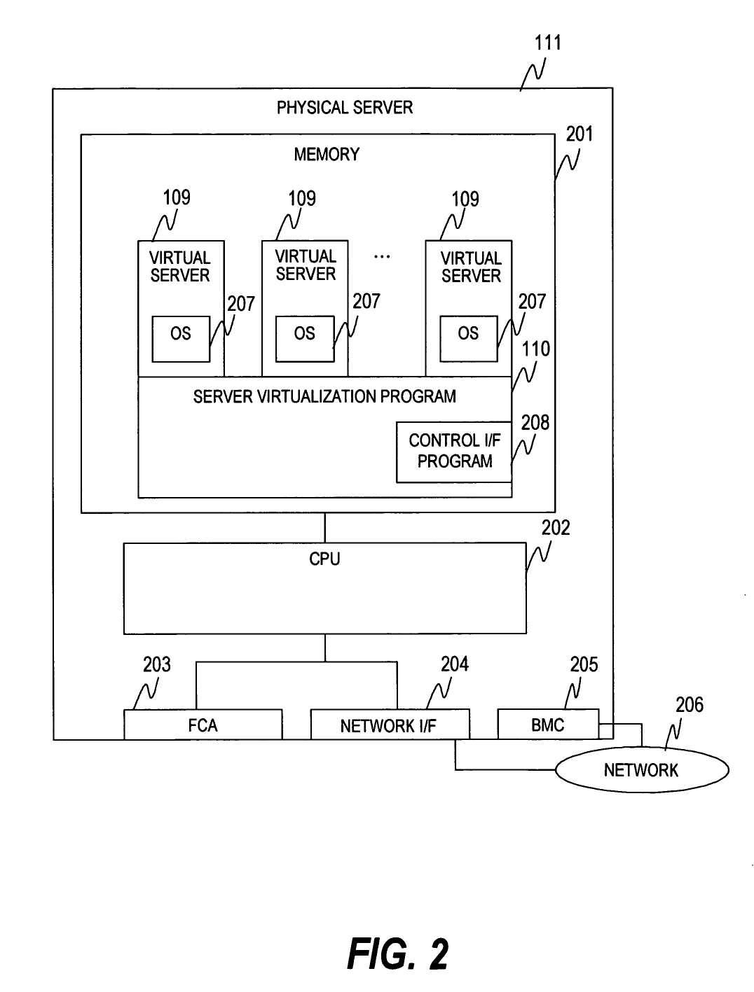

FIG. 2 is a block diagram showing the physical server 111 in the first embodiment of this invention.

The physical server 111 comprises a memory 201, a central processing unit (CPU) 202, a fibre channel adapter (FCA) 203, a network interface 204 and a baseboard management controller (BMC) 205.

The memory 201, FCA 203 and the network interface 204 are connected to CPU 202.

In the memory 201, the server virtualization program 110 is stored.

The physical server 111 is connected to the network 206 via the network interface 204. In addition, BMC 205 is also connected to the network 206. FCA 203 is connected to a storage device for storing a program executed in the physical server 111. The network interface 204 is an interface for communication between the program executed in the physical server 111 and an external device.

BMC 205 manages a state of main hardware such as CPU 202 and the memory 201 of the physical server 111. For example, BMC 205 notifies another device that a fault occurs in CPU 202 via the network 206 when BMC detects the fault of CPU 202.

When the physical server 111 is activated, the server virtualization program 110 is activated. The server virtualization program 110 constructs the plurality of virtual servers 109.

Specifically, the server virtualization program 110 constructs the plurality of virtual servers 109 in the physical server 111 by splitting the resources such as CPU 202 of the physical server 111 and allocating it to the virtual server 109. Each constructed virtual server 109 can operate an operating system (OS) 207.

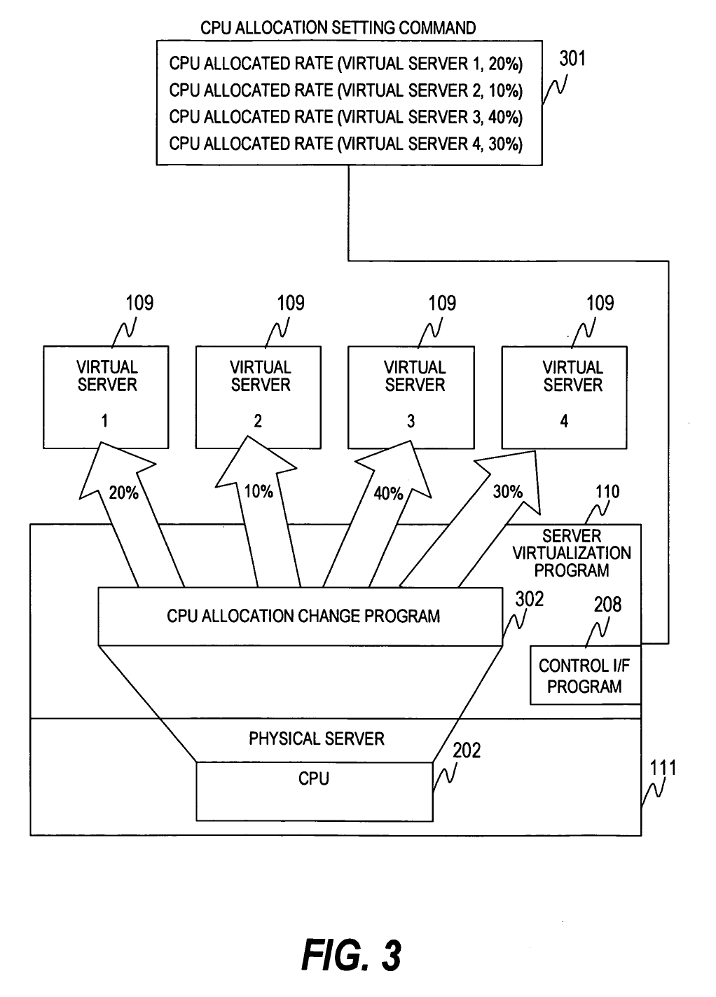

In addition, the server virtualization program 110 includes a control interface program 208 and a CPU allocation change program 302 described in relation to FIG. 3 later. The control interface program 208 and the CPU allocation change program 302 are equivalent to subprograms of the server virtualization program 110.

The control interface program 208 constructs the virtual server 109 and functions as a user interface for setting a rate allocated to the virtual server 109 of the resource of the physical server 111. The CPU allocation change program 302 actually allocates the resource of the physical server 111 to the virtual server 109.

FIG. 3 shows workload management in the first embodiment of this invention.

The CPU allocation setting command 301 is input to the server virtualization program 110 via the control interface program 208.

The CPU allocation setting command 301 includes a rate allocated to each virtual server 109 and is a command for changing a rate allocated to the virtual server 109 to any rate included in the CPU allocation setting command 301.

The server virtualization program 110 instructs the CPU allocation change program 302 to change a rate of CPU 202 allocated to each virtual server 109 according to the CPU allocation setting command 301. The instructed CPU allocation change program 302 changes a rate of CPU 202 allocated to the virtual server 109 according to the CPU allocation setting command 301.

The server virtualization program 110 can instruct to change a rate of CPU 202 in the physical server 111 allocated to each virtual server 109 according to the CPU allocation setting command 301 specified by an administrator. In this case, the rate means a rate represented in a percentage of CPU 202 allocated to each virtual server 109 when the performance of CPU 202 in the physical server 111 is 100%.

Hereby, when the specific virtual server 109 has a heavy load, a rate of CPU 202 allocated to the virtual server 109 having a light load is allocated to the virtual server 109 having the heavy load. Therefore, CPU 202 of the physical server 111 can be effectively used.

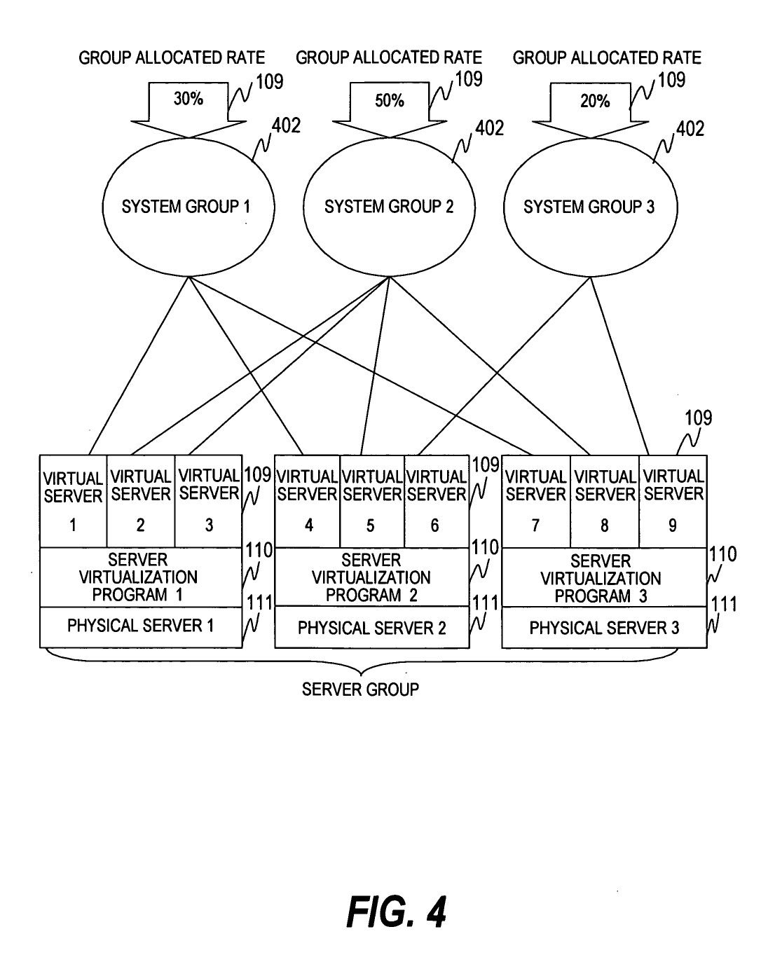

FIG. 4 shows the group management of virtual servers 109 in the first embodiment of this invention.

A group is formed by the virtual servers 109 operated in the plurality of physical servers 111. Hereby, the administrator can specify an allocated rate every group. The workload setting program 104 automatically determines a rate of CPU 202 allocated to each virtual server 109 based upon an allocated rate specified by the administrator.

In addition, the physical servers 111 in each of which the server virtualization program 110 is operated are grouped into a server group.

For an example of grouping the virtual servers 109, a method of grouping the virtual servers 109 every task provided by the virtual server 109 can be given. For example, a system group 1 provides a task A, a system group 2 provides a task B, and a system group 3 provides a task C.

As described above, the virtual servers are grouped every task so as to facilitate group management when the plurality of virtual servers 109 to which the administrator provides a single task are distributed among the plurality of physical servers 111.

When the plurality of virtual servers 109 to which the single task is provided are distributed among the plurality of physical servers 111, the administrator is required to set a rate of CPU 202 allocated to the virtual server 109 every physical server 111 in consideration of correspondence between the virtual servers 109 forming a task system and the physical server 111 and the performance of CPU 202 in each physical server 111 in a method of setting a rate of CPU 202 allocated to the virtual server 109 every single physical server 111.

According to this embodiment, as the virtual servers 109 are grouped every task provided by the virtual servers 109, the administrator can specify a rate of CPU 202 in the physical server 111 allocated to the virtual server 109 every group. Hereby, when the plurality of virtual servers 109 to which the single task is provided are distributed among the plurality of physical servers 111, it is also facilitated for the administrator to set a rate allocated to the virtual server 109.

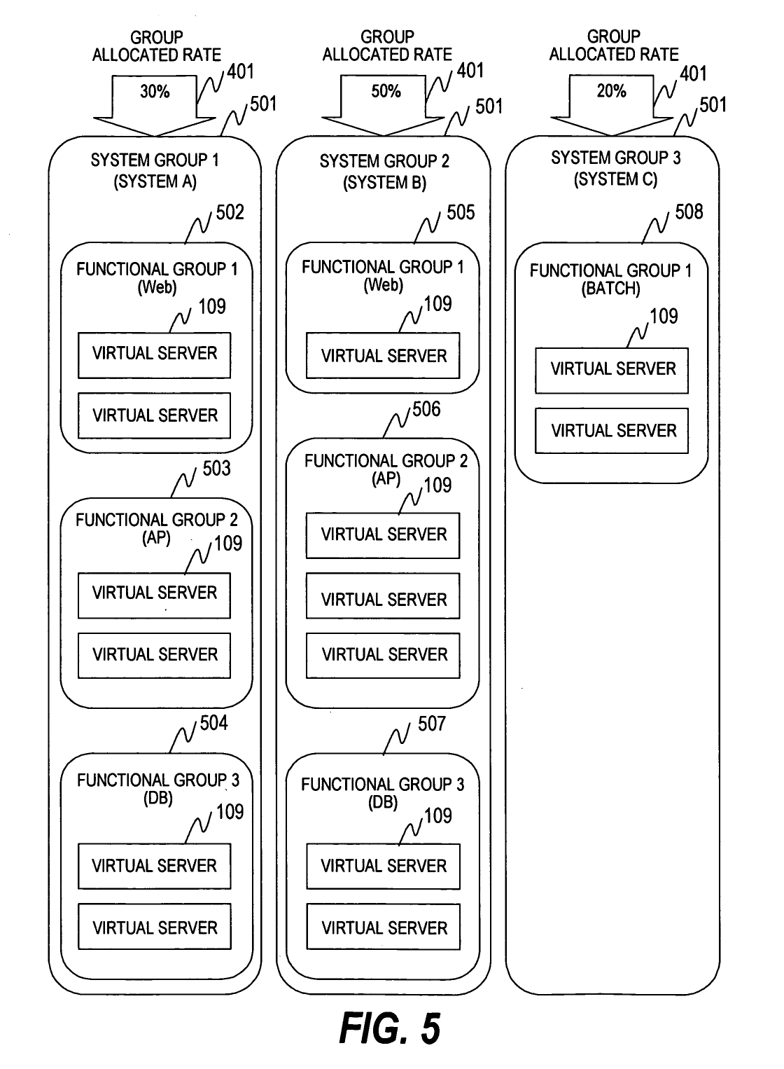

FIG. 5 shows the definition of functional groups in the first embodiment of this invention.

The virtual servers 109 grouped every task shown in FIG. 4 are further grouped every function of the virtual server 109. That is, in each system group 1 to 3 which is a group every task, the virtual servers 109 are further grouped into functional groups 502 to 508. The functional groups 502 to 508 are equivalent to subgroups in the system groups 501.

For example, when virtual servers 109 included in the system group 1 (501) are grouped into a web server group, an application (AP) server group and a database (DB) server group, the web server group as the functional group 1 (502), the AP server group as the functional group 2 (503) and the DB server group as the functional group 3 (504) are grouped every function.

The administrator can specify a rate allocated to each functional group by grouping every function in consideration of a characteristic of a load allocated to virtual servers 109 every functional group when CPU 202 is operated. For example, when a load of the AP server group 503 onto CPU 202 is heavier than another functional group (502 or 504) in the same system group, the administrator can allocate CPU 202 in the physical server 111 to the AP server group 503 more.

Hereby, when a characteristic of a load allocated to the virtual server 109 when CPU 202 is operated is different every functional group, a workload can be more exactly managed.

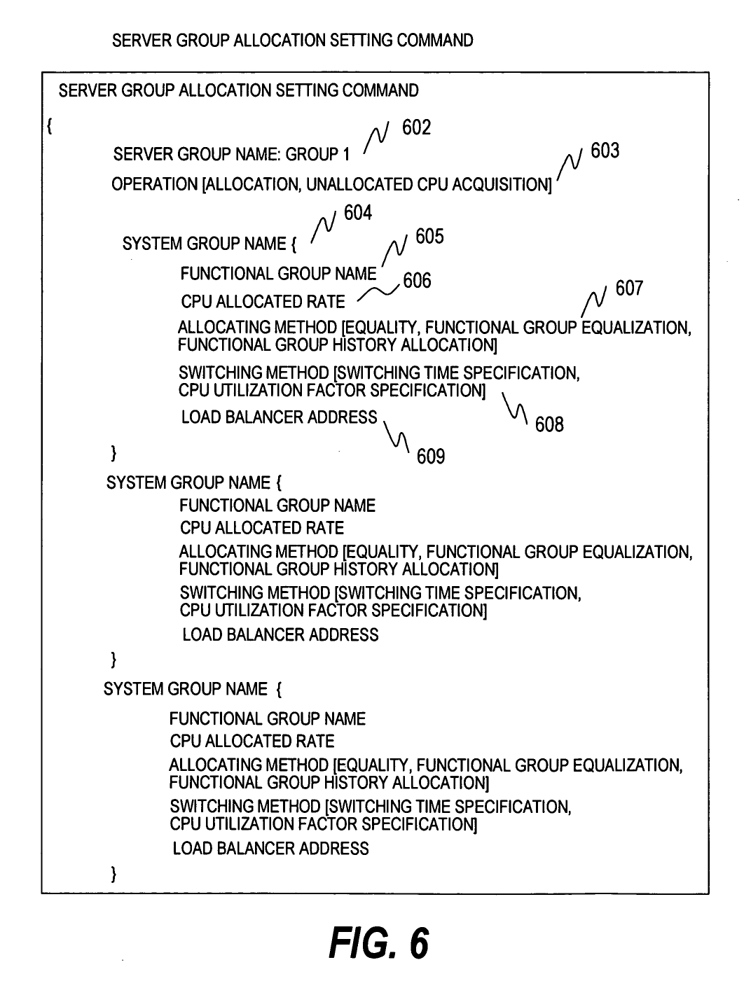

FIG. 6 shows a server group allocation setting command in the first embodiment of this invention.

The server group allocation setting command includes a server group name 602, operation 603, system group names 604, functional group names 605, CPU allocated rates 606, allocating methods 607, switching methods 608 and load balancer addresses 609. Every system group, the server group name 602, the operation 603, the system group name 604, the functional group name 605, the CPU allocated rate 606, the allocating method 607, the switching method 608 and the load balancer address 609 are defined.

A field of the server group name 602 includes a name of a server group including a plurality of physical servers 111. The operation 603 shows the operation of the server group allocation setting command. Specifically, a field of the operation 603 includes “allocation” which is a command for changing a rate allocated to the virtual server 109 of CPU 202 and “unallocated CPU acquisition” which is a command for acquiring the information of CPU 202 not allocated to the virtual server 109 yet. The administrator selects either of “allocation” or “unallocated CPU acquisition” and can include it in the server group allocation setting command.

When “allocation” is selected in the operation 603, the administrator sets the system group name 604, the functional group name 605, the CPU allocated rate 606, the allocating method 607, the switching method 608 and the load balancer address 609. When “unallocated CPU acquisition” is selected in the operation 603, the administrator is not required to set the system group name 604, the functional group name 605, the CPU allocated rate 606, the allocating method 607, the switching method 608 and the load balancer address 609.

In a field of the system group name 604, the system group including the virtual servers 109 to which CPU 202 is allocated is specified. In a field of the functional group name 605, the functional group including the virtual servers 109 to which CPU 202 is allocated is specified. In a field of the CPU allocated rate 606, a rate of the performance of CPU 202 allocated to the system group specified in the system group name 602 when the performance of CPU 202 in all physical servers 111 in the server group specified in the server group name 602 is 100% is specified.

In a field of the allocating method 607, a method of allocating the plurality of virtual servers 109 is specified. Specifically, in the allocating method 607, “equality”, “functional group equalization” and “functional group history allocation” are prepared. “Equality” means allocating the performance of CPU 202 to the plurality of virtual servers 109 included in the system group as equally as possible. “Functional group equalization” means allocating the performance of CPU 202 to the plurality of virtual servers 109 included in the functional group as equally as possible. “Functional group history allocation” means that an allocated rate is changed every functional group based upon a history of the operation of the virtual servers 109 in the past functional group and CPU 202 is allocated to the plurality of virtual servers 109 included in the functional group. The administrator selects any of “equality”, “functional group equalization” and “functional group history allocation” in the allocating method 607 and can include it in the server group allocation setting command.

In the switching method 608, “switching time specification” and “CPU utilization factor specification” are prepared. “Switching time specification” means gradually changing a rate of CPU 202 allocated to the virtual server 109 in specified time when CPU 202 is newly allocated to the virtual server 109. “CPU utilization factor specification” means gradually changing a rate of CPU 202 allocated to the virtual server 109 not to exceed a specified utilization factor of CPU 202, referring a utilization factor of CPU 202 in the physical server 111 when CPU 202 is newly allocated to the virtual server 109. In a field of the load balancer address 609, the load balancer that distributes a request from the client terminal 113 among the virtual servers 109 included in the system group is specified.

FIG. 7 shows the server configuration table 103 in the first embodiment of this invention.

The server configuration table 103 includes physical server ID 701, a server component 702, virtualization program ID 703, virtual server ID 704 and an allocated rate 705.

In a field of the physical server ID 701, a unique identifier of the physical server 111 is registered. In a field of the server component 702, components of the physical server 111 are registered. For example, in the field of the server component 702, the information of resources of the physical server 111 related to workload management such as an operating clock frequency of CPU 202 and the capacity of the memory 201 is registered. In this embodiment, the operating clock frequency of CPU 202 is an index showing the performance of CPU 202, however, the index showing the performance of CPU 202 is not limited to the operating clock frequency. For example, an index such as a result of a specific bench mark and performance including the performance of input/output is also conceivable.

In a field of the virtualization program ID 703, a unique identifier of the server virtualization program 110 operated in the physical server 111 is registered. In a field of the virtual server ID 704, a unique identifier of the virtual server 109 constructed by the server virtualization program 110 is registered.

In a field of the allocated rate 705, a rate of CPU 202 allocated to the virtual server 109 is registered. The allocated rate means a rate of the performance of the physical server 111 allocated to each virtual server 109 when the performance of the single physical server 111 is 100%.

The management server 101 can manage correspondence between the physical server 111 and the virtual server 109 and a rate of the performance of the physical server 111 allocated to each virtual server 109 based upon the server configuration table 103.

FIG. 8 shows the group definition table 107 in the first embodiment of this invention.

The group definition table 107 includes a server group 807, a system group 801, an allocated rate 802, priority 803, a functional group 804, weight 805 and virtual server ID 806.

In a field of the server group 807, a server group is registered. The server group means a group formed by the physical servers 111 (see FIG. 4).

In a field of the system group 801, a system group is registered. The system group means a group configured by the plurality of virtual servers 109 that process the same task for example. In a field of the allocated rate 802, a rate allocated to the system group is registered when the performance of the whole server group is 100%. For example, the allocated rate 802 means a rate of the total performance of three physical servers 111 when the server group is configured by the three physical servers 111. In a field of the priority 803, priority showing resources of the physical servers 111 in which system group in the server group are to be preferentially allocated is registered. A workload is precedently allocated to a system group having high priority. Priority ‘1’ denotes the highest priority. The administrator specifies the priority 803.

In a field of the functional group 804, a functional group in which virtual servers 109 in a system group are further grouped based upon a function of each virtual server 109 is registered. When the virtual servers 109 in the system group are managed in groups based upon their functions, functional groups are made. In a field of the weight 805, ratio of performance allocated to each functional group when the performance of a system group is 100% is registered. When the ratio of allocated performance is changed every functional group, weight 805 is specified. In a field of the virtual server ID 806, a unique identifier of a virtual server 109 included in a functional group is registered.

The group definition table 107 includes the information of a server group, a system group and a functional group respectively defined by the management server 101 to which a plurality of physical servers 111 and a plurality of virtual servers 109 operated in each physical server 111 belong. In addition, the group definition table 107 includes a rate allocated every system group and weight every functional group.

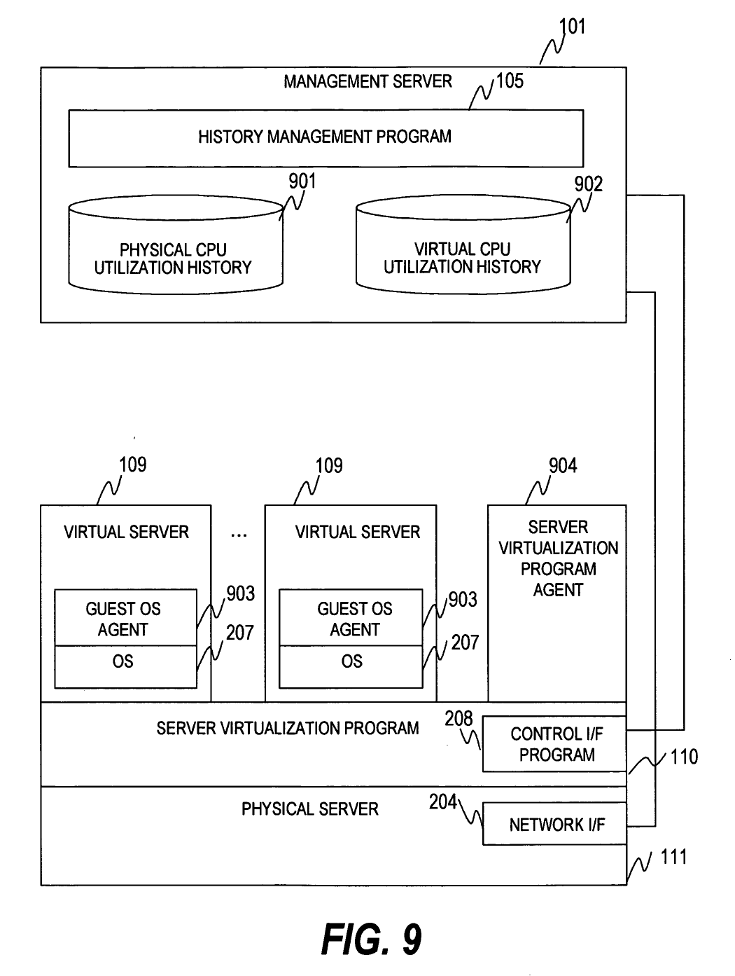

FIG. 9 shows the configuration of the history management program 105 in the first embodiment of this invention.

The history management program 105 acquires a history of the operation of each physical server 111 and a history of the operation of each virtual server 109. Specifically, the history management program 105 acquires a physical CPU utilization factor history data 901 which is a utilization factor of CPU 202 of each physical server 111. In addition, the history management program 105 acquires a virtual CPU utilization factor history data 902 which is a utilization factor of CPU 202 to which each virtual server 109 is allocated.

The physical CPU utilization factor history data 901 is periodically acquired by a server virtualization program agent 904 on the server virtualization program 110 operated in the physical server 111. In the meantime, the virtual CPU utilization factor history data 902 is periodically acquired by a guest OS agent 903 on OS 207 operated in the virtual server 109.

As the guest OS agent 903 and the server virtualization program agent 904 are provided on different layers, histories of the operation on the different layers on which each agent is operated can be acquired. That is, histories of operation on all layers can be acquired by providing agents operated on two different layers.

The virtual CPU utilization factor history data 902 includes a rate of CPU 202 allocated to each virtual server 109 acquired via the control interface program 208. As the allocated rate of CPU 202 and a utilization factor of CPU 202 are closely related, a workload can be exactly allocated by acquiring the CPU utilization factor and the CPU allocated rate.

Information acquired by the server virtualization program agent 904 and the guest OS agent 903 is transferred to the management server 101 via the network interface 204.

The guest OS agent 903 can also acquire the configuration of a virtual server via the guest OS 207. The configuration of the virtual server 109 includes the performance of CPU 202 allocated to the virtual server and the capacity of a memory allocated to the virtual server.

Similarly, the server virtualization program agent 904 can acquire the performance of CPU 202 of the physical server 111 and the capacity of the memory via the server virtualization program 110. As described above, more information can be acquired by arranging the agents on different layers.

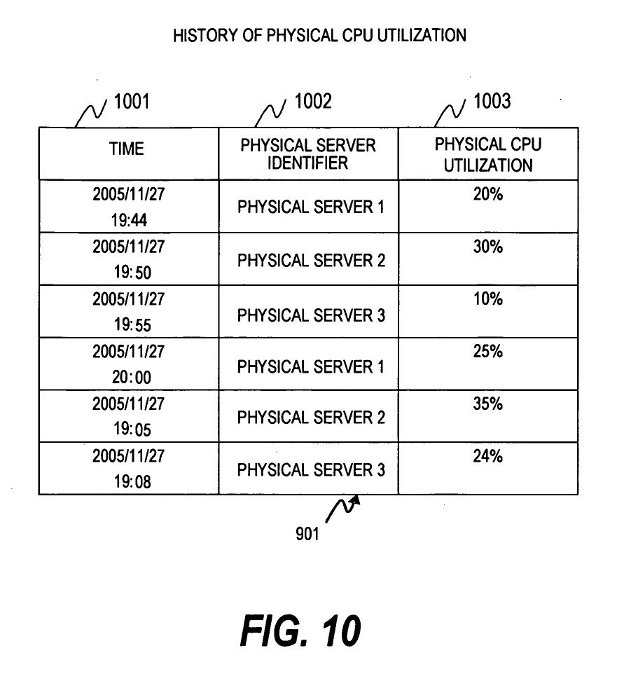

FIG. 10 shows the physical CPU utilization factor history data 901 in the first embodiment of this invention.

The physical CPU utilization factor history data 901 includes items of time 1001, a physical server identifier 1002 and a physical CPU utilization factor 1003.

In a field of the time 1001, time when the history management program 105 acquired the physical CPU utilization factor history data 901 is registered. In a field of the physical server identifier 1002, a unique identifier of the acquired physical server 111 is registered. In a field of the physical CPU utilization factor 1003, a utilization factor of CPU 202 of the physical server 111 is registered.

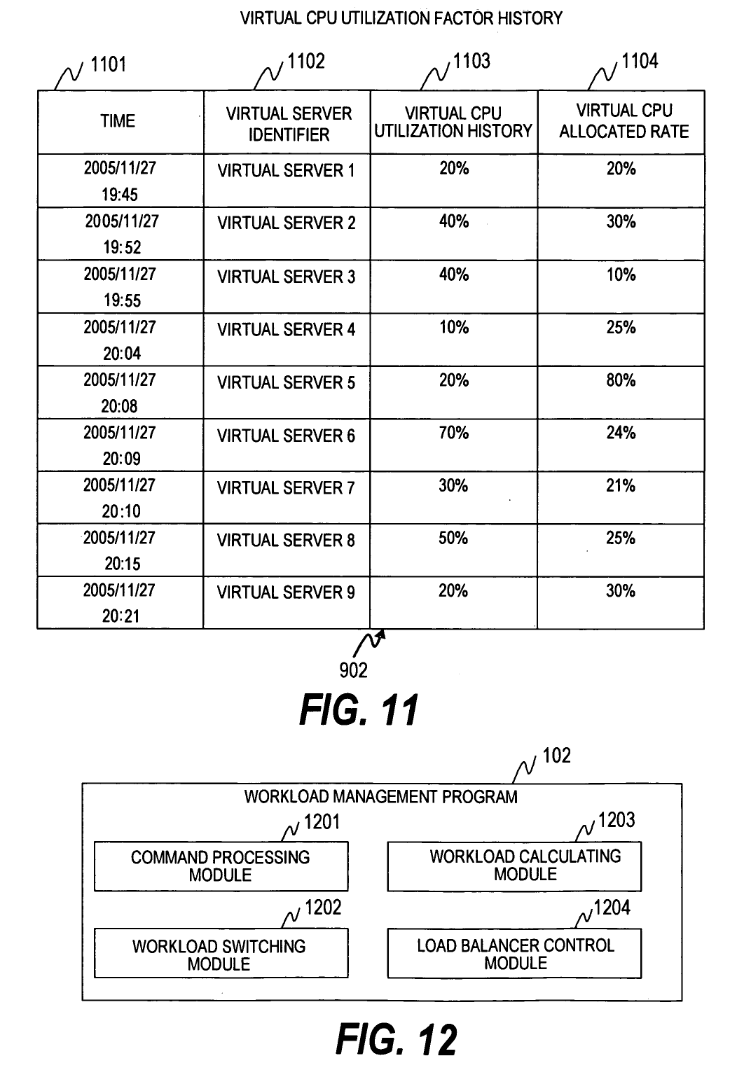

FIG. 11 shows the virtual CPU utilization factor history data 902 in the first embodiment of this invention.

In a field of time 1101, time when the history management program 105 acquired the virtual CPU utilization factor history data 902 is registered. In a field of a virtual server identifier 1102, a unique identifier of the acquired virtual server 109 is registered. In a field of a physical CPU allocated rate 1103, a rate of CPU 202 allocated to each virtual server 109 is registered. The physical CPU allocated rate 1103 is information acquired by the history management program 105 via the control interface program 208 in the server virtualization program 110. In a field of a virtual CPU utilization factor 1104, a utilization factor of CPU 202 by the virtual server 109 is registered.

The physical CPU utilization factor history data 901 and the virtual CPU utilization factor history data 902 are used for efficiently executing a process in which the workload management program 102 allocates CPU 202 to the virtual server 109.

FIG. 12 shows the configuration of the workload management program 102 in the first embodiment of this invention.

The workload management program 102 includes a command processing module 1201, a workload switching module 1202, a workload calculating module 1203 and a load balancer control module 1204.

The command processing module 1201 accepts the server group allocation setting command shown in FIG. 6. The workload calculating module 1203 calculates a rate allocated to the virtual server 109. The workload switching module 1202 allocates CPU 202 in the physical server 111 to the virtual server 109 based upon an allocation calculated by the workload calculating module 1203 and switches a workload. The load balancer control module 1204 controls the load balancer in a link with switching the workload.

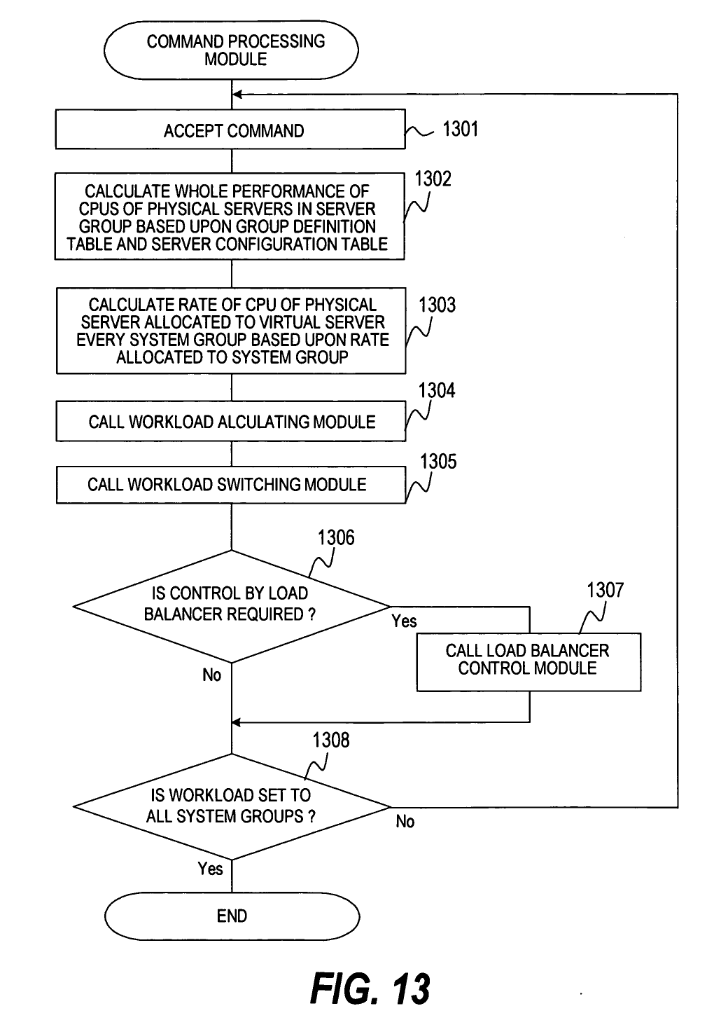

FIG. 13 is a flowchart showing a process by the command processing module 1201 in the first embodiment of this invention.

First, the command processing module 1201 accepts the server group allocation setting command (a step 1301).

Next, the command processing module 1201 calculates the total performance of all CPUs 202 in physical servers 111 included in a server group, referring to the group definition table 107 and the server configuration table 103 (a step 1302).

Specifically, the command processing module 1201 selects a server group corresponding to a server group specified in the field of the server group name 602 in the server group allocation setting command, referring to the group definition table 107. The command processing module 1201 retrieves all virtual servers 109 included in the selected server group, referring to the group definition table 107. The command processing module 1201 retrieves the server configuration table 103 and acquires the performance (e.g., an operating clock frequency) of CPU 202 in the physical server 111 to which the retrieved virtual server 109 belongs. The command processing module 1201 calculates the total of the performance of CPU 202 and acquires the total performance of all CPUs 202 in the whole server group.

Next, the command processing module 1201 calculates a rate of CPU 202 allocated every system group based upon an allocation in units of the system group specified by the administrator (a step 1303). Specifically, the command processing module 1201 acquires a rate of CPU 202 allocated to the system group by calculating a product of the CPU allocated rate 606 specified in the server group allocation setting command and the total performance of all CPUs 202 in the whole server group calculated by the command processing module 1201 in the step 1302.

For example, when the total performance of all CPUs 202 in the whole server group is 8 GHz and the CPU allocated rate 606 is specified as 40%, a rate of CPU 202 allocated to the system group is 3.2 GHz (8 GHz×40%).

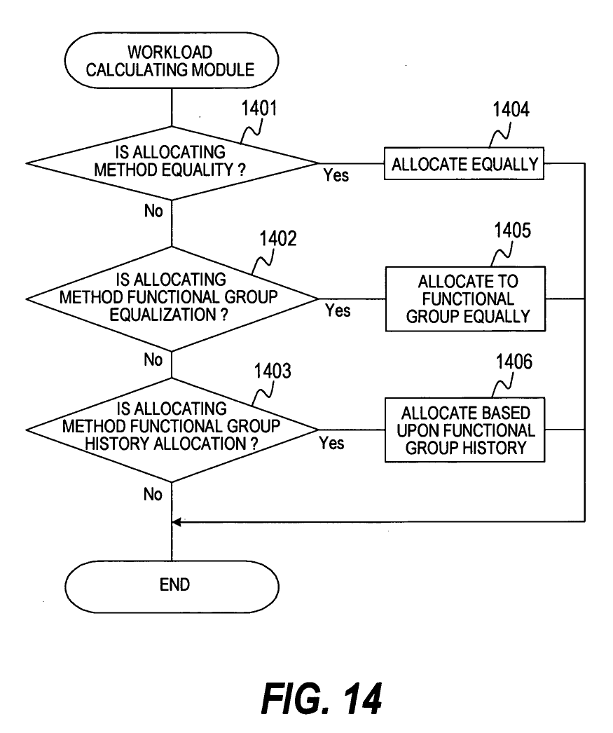

Next, the command processing module 1201 calls the workload calculating module 1203 (a step 1304). The workload calculating module 1203 determines a rate allocated to virtual servers 109 included in the system group based upon the rate allocated to the system group calculated by the command processing module 1201 in the step 1303. This process will be described in relation to FIGS. 14 to 18 in detail below.

Next, the command processing module 1201 calls the workload switching module 1202 (a step 1305).

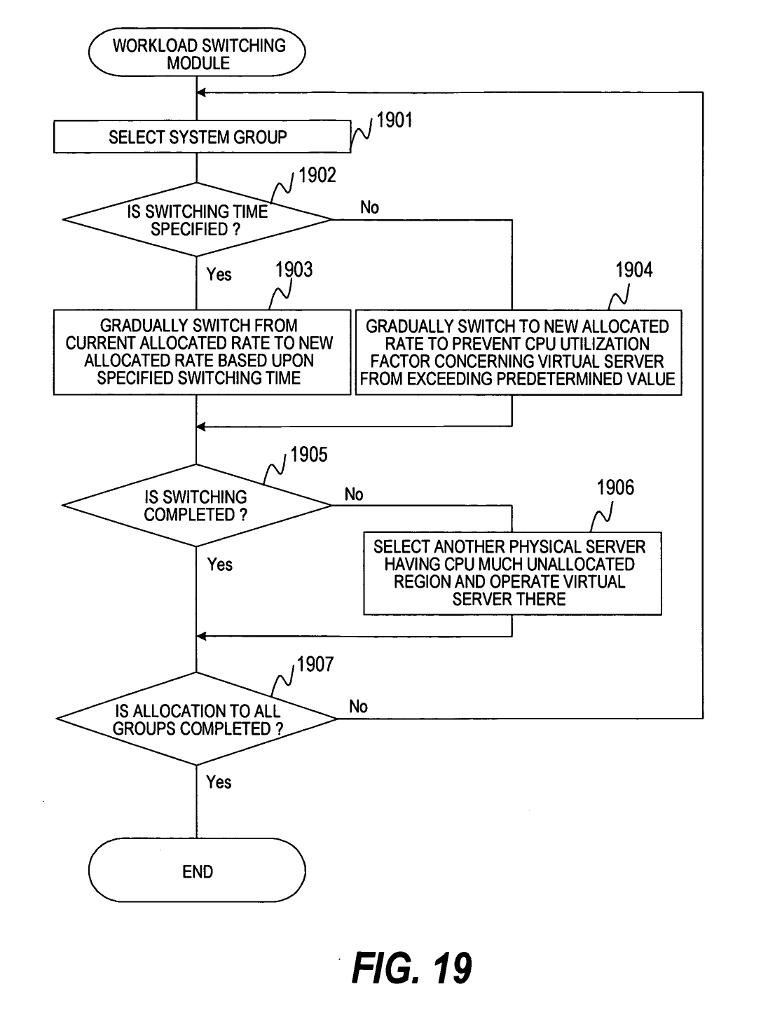

The workload switching module 1202 allocates CPU 202 to the virtual server 109 based upon the rate of CPU 202 allocated every virtual server 109 calculated by the workload calculating module 1304 in the step 1304. This process will be described in relation to FIG. 19 in detail below.

Next, the command processing module 1201 determines whether control by the load balancer 112 is required or not (a step 1306). Specifically, when the load balancer address 609 is specified in the server group allocation setting command, the command processing module 1201 determines that the control by the load balancer 112 is required. When the command processing module 1201 determines that the control by the load balancer 112 is required, processing proceeds to a step 1307, and when the command processing module 1201 determines that the control by the load balancer 112 is not required, processing proceeds to a step 1308.

When the command processing module 1201 determines that the control by the load balancer 112 is required, the command processing module 1201 calls the load balancer control module 1204 (the step 1307).

Next, the command processing module 1201 determines whether a workload is set to all system groups or not (the step 1308). When the command processing module 1201 determines that the workload is set to the all the system groups, processing by the command processing module 1201 is finished. In the meantime, when the command processing module 1201 determines that a workload is not set to all the system groups, control is returned to the step 1301.

FIG. 14 is a flowchart showing a process by the workload calculating module 1203 in the first embodiment of this invention.

The workload calculating module 1203 is called by the command processing module 1201.

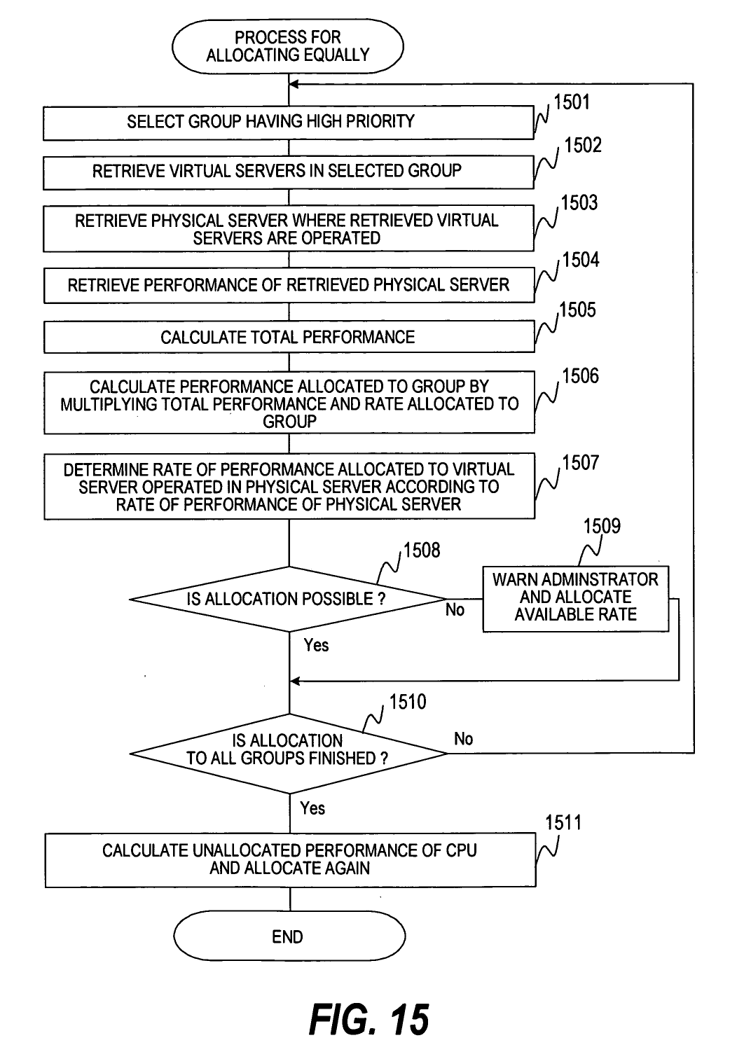

First, the workload calculating module 1203 determines whether the allocating method 607 specified in the server group allocation setting command is “equality” or not (a step 1401). When the allocating method 607 is “equality”, the workload calculating module 1203 makes processing proceed to a step 1404. In the meantime, when the allocating method 607 is not “equality”, the workload calculating module 1203 makes processing proceed to a step 1402. The step 1404 will be described in relation to FIG. 15 below.

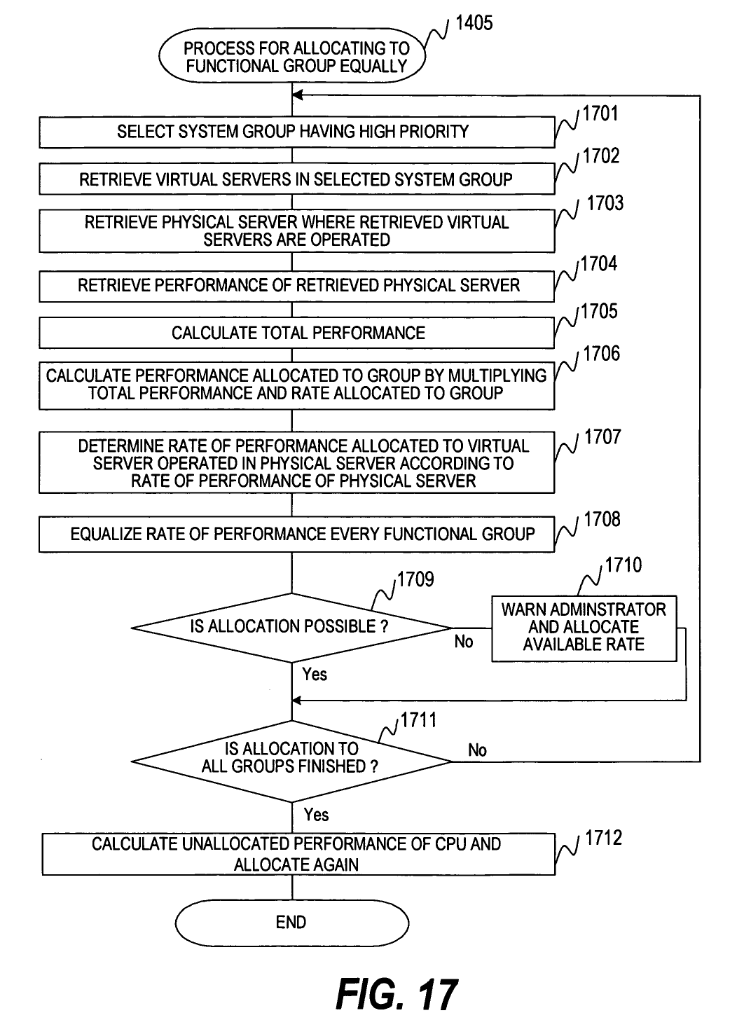

Next, the workload calculating module 1203 determines whether “functional group equalization” is specified as the allocating method 607 in the server group allocation setting command or not (a step 1402). When the allocating method 607 is “functional group equalization”, the workload calculating module 1203 proceeds to a step 1405. In the meantime, when the allocating method 607 is not “functional group equalization”, the workload calculating module 1203 proceeds to a step 1403. The contents of the step 1405 will be described in relation to FIG. 17.

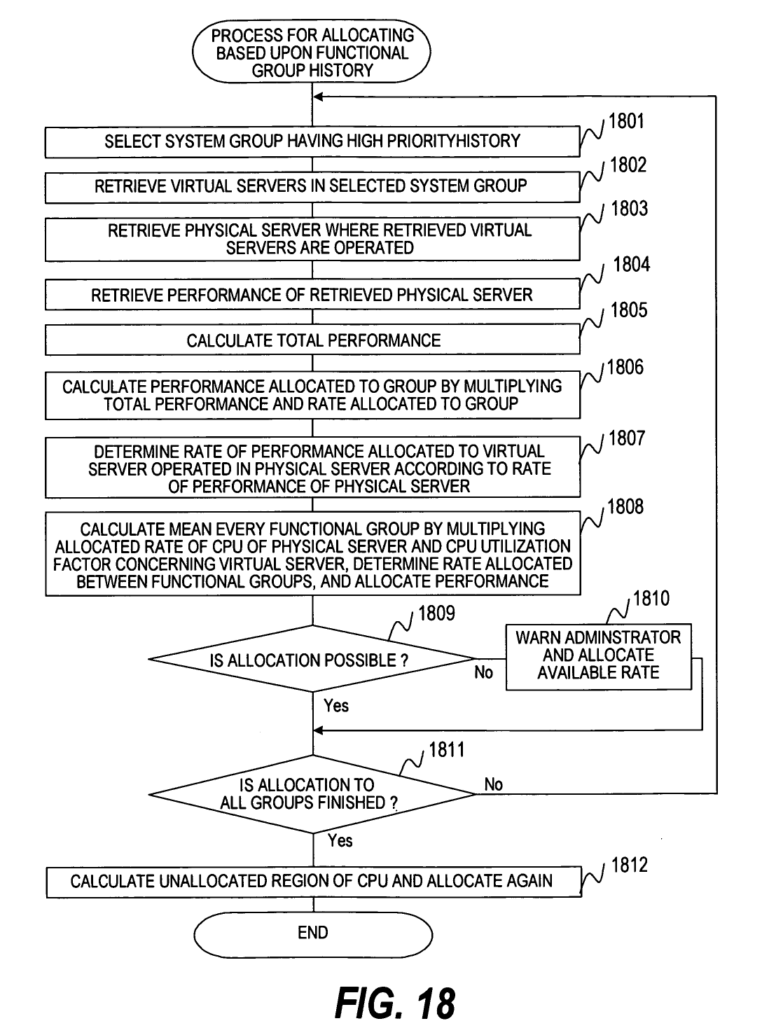

Next, the workload calculating module 1203 determines whether “functional group history allocation” is specified as the allocating method 607 in the server group allocation setting command or not (the step 1403). When the allocating method 607 is “functional group history allocation”, the workload calculating module 1203 proceeds to a step 1406. In the meantime, when the allocating method 607 is not “functional group history allocation”, processing by the workload calculating module 1203 is finished. The contents of the step 1406 will be described in relation to FIG. 18.

FIG. 15 is a flowchart showing a process for allocating equally (the step 1404) in the first embodiment of this invention.

In the process for allocating equally, the performance of CPU 202 is allocated so that a rate of CPU 202 allocated to the plurality of virtual servers 109 in the system group is as equal as possible. For example, when the allocation of the performance to the system group is 3 GHz and three virtual servers are included in the system group, the allocation of the performance to each virtual server 109 is 1 GHz.

First, the workload calculating module 1203 selects a system group having high priority, referring to the priority 803 in the group definition table 107 (a step 1501).

Next, the workload calculating module 1203 retrieves virtual servers 109 included in the system group selected by the workload calculating module 1203 in the step 1501, referring to the group definition table 107 (a step 1502).

Next, the workload calculating module 1203 retrieves a physical server 111 in which the virtual server 109 retrieved by the workload calculating module 1203 in the step 1502 is operated, referring to the server configuration table 103 (a step 1503).

Next, the workload calculating module 1203 retrieves the performance of CPU 202 of the physical server 111 retrieved by the workload calculating module 1203 in the step 1503, referring to the server configuration table 103 (a step 1504).

The workload calculating module 1203 calculates a total value of the performance of CPU 202 in each physical server 111 retrieved by the workload calculating module 1203 in the step 1504 (a step 1505). That is, the total value is equivalent to the total performance of CPUs 202 in the whole server group.

Next, the workload calculating module 1203 multiplies the total value calculated in the step 1505 and a rate allocated to the system group and calculates the performance of CPUs 202 allocated to the system group (a step 1506).

The workload calculating module 1203 determines a rate of the performance of CPU 202 allocated to the virtual server 109 operated in the physical server 111 corresponding to a rate of the performance of CPU 202 allocated to each virtual server 109 (a step 1507). That is, a rate of the performance of CPU 202 allocated to the virtual server 109 operated in the physical server 111 CPU 202 of which has only small performance is reduced.

The workload calculating module 1203 may also allocate the performance of CPU 202 to the virtual server 109 so that the rate is proportional to a rate of the performance of CPU 202 allocated to each virtual server 109.

The workload calculating module 1203 may also allocate the performance of CPU 202 to the virtual server 109 discretely (so that a rate gradually increases) based upon the rate of the performance of CPU 202 allocated to each virtual server 109.

For example, a case that the performance of CPU in a physical server 1 is 1 GHz, the performance of CPU in a physical server 2 is 2 GHz, the performance of CPU in a physical server 3 is 3 GHz, a virtual server 1 is operated in the physical server 1, a virtual server 2 is operated in the physical server 2 and a virtual server 3 is operated in the physical server 3 will be described below. The performance of CPUs in the system group is allocated to the virtual server 1, the virtual server 2 and the virtual server 3 at the ratio of the performance of CPUs 202 among the physical servers, that is, at the ratio of 1:2:3.

Next, the workload calculating module 1203 determines whether a rate allocated to each virtual server 109 determined in the step 1507 can be allocated to the physical server 111 in which each virtual server 109 is operated or not (a step 1508). Specifically, the workload calculating module 1203 determines whether the allocation the virtual server 109 is smaller than the unallocated performance of CPU 202 of the physical server 111 or not.

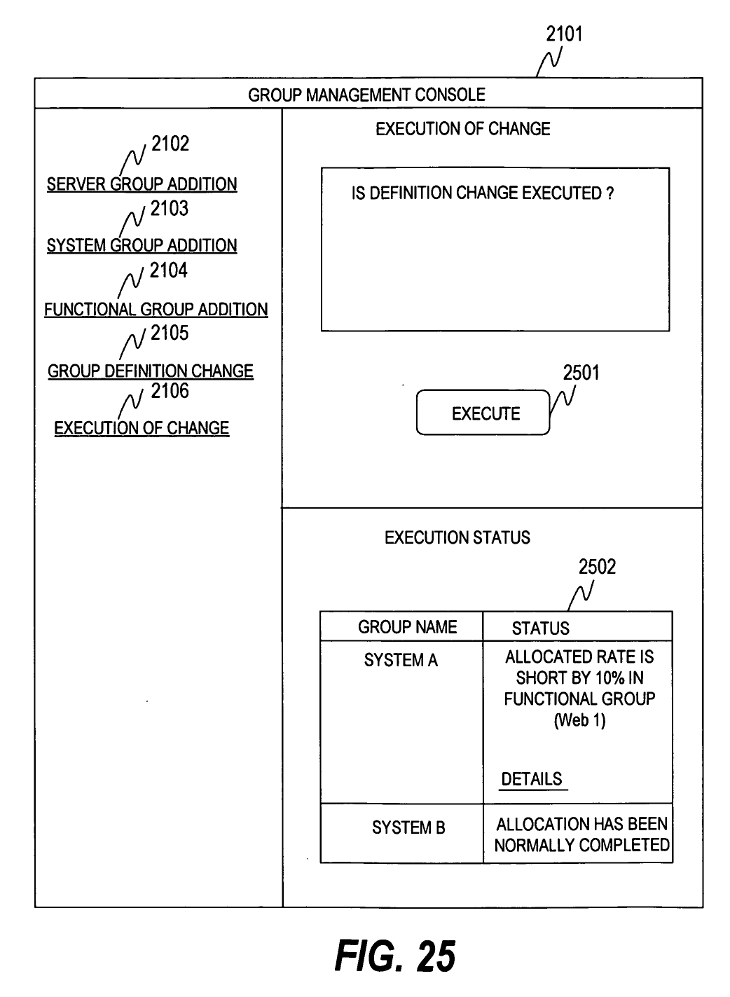

When it is determined in the step 1508 that the rate allocated to each virtual server cannot be allocated, warning that the rate cannot be allocated is informed the administrator and allocable performance of CPU 202 is allocated to each virtual server 109. In this embodiment, the warning is displayed on a screen shown in FIG. 25 and is informed the administrator, however, a message is sent to the administrator to inform the administrator of it. The information includes notifying or display.

Next, the workload calculating module 1203 determines whether the allocating process is applied to all system groups or not (a step 1510). When the allocating process is not applied to all system groups, control is returned to the step 1501. When the allocating process is applied to all system groups, the process proceeds to a step 1511.

The workload calculating module 1203 calculates an unallocated region of CPU 202. When there is CPU 202 having an unallocated region, the workload calculating module 1203 allocates the performance of the corresponding CPU 202 to the virtual server 109 to which the allocation calculated in the step 1507 is not allocated (the step 1511). That is, if another physical server 111 comprises CPU 202 having an unallocated region when it is determined in the step 1508 that the above-mentioned allocation cannot be allocated, the performance of its CPU 202 is allocated to its virtual server 109.

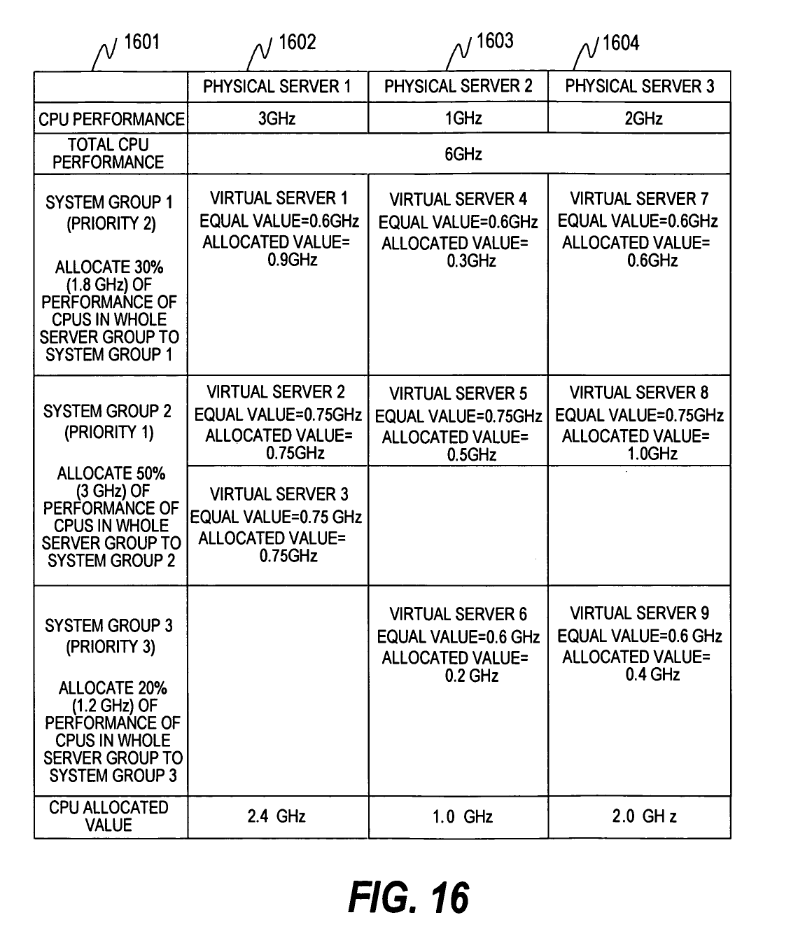

FIG. 16 shows an example of a process for allocating equally in the first embodiment of this invention.

The example that CPUs of three physical servers 1 to 3 are allocated to virtual servers 1 to 9 included in system groups 1 to 3 will be described below. The physical server 1 operates the virtual server 1, the virtual server 2 and the virtual server 3. The physical server 2 operates the virtual server 4, the virtual server 5 and the virtual server 6. The physical server 3 operates the virtual server 7, the virtual server 8 and the virtual server 9.

A server group is configured by the physical servers 1 to 3. The performance of CPU in the physical server 1 is 3 GHz, the performance of CPU in the physical server 2 is 1 GHz, and the performance of CPU in the physical server 3 is 2 GHz. Therefore, the performance of CPUs in the whole server group is 6 GHz.

Thirty percents of the performance of CPUs in the whole server group is allocated to the system group 1. Fifty percents of the performance of CPUs in the whole server group is allocated to the system group 2. Twenty percents of the performance of CPUs in the whole server group is allocated to the system group 3.

Specifically, the allocation of the system group 1 is 1.8 GHz acquired by multiplying 6 GHz and 30%. The allocation of the system group 2 is 3 GHz acquired by multiplying 6 GHz and 50%. The allocation of the system group 3 is 1.2 GHz acquired by multiplying 6 GHz and 20%.

If the allocation of the system group is a simple allocation equally allocated to each virtual server 109, 0.6 GHz acquired by dividing 1.8 GHz by 3 is allocated to the virtual server 1, the virtual server 4 and the virtual server 7 respectively included in the system group 1. 0.75 GHz acquired by dividing 3.0 GHz by 4 is allocated to the virtual server 2, the virtual server 3, the virtual server 5 and the virtual server 8 respectively included in the system group 2. 0.6 GHz acquired by dividing 1.3 GHz by 2 is allocated to the virtual server 6 and the virtual server 9 respectively included in the system group 3.

However, when the performance of CPU 202 is allocated to each virtual server 109 according to a method of allocating simply equally in a case that the performance of CPU 202 of each physical server 111 is different, the performance of CPU 202 which can be allocated to the virtual server 109 is unbalanced between/among the physical servers 111. That is, when the same allocation as that to the virtual server 109 under the physical server 111 CPU 202 of which has large performance is allocated to the virtual server 109 under the physical server 111 CPU 202 of which has only small performance, the allocable performance of CPU 202 is all allocated to the physical server 111 CPU 202 of which has only small performance. That is, the allocable performance of CPU 202 in the physical server 111 is used up for the virtual server 109 under the physical server 111 CPU 202 of which has only small performance.

Therefore, the performance of CPUs 202 in the whole server group is allocated to each virtual server 109 based upon the ratio of the performance of CPU 202 in each physical server 111. Specifically, the performance of CPUs in the whole server group is allocated to the virtual servers 1 to 9 under each physical server 1 to 3 at the ratio of 3:1:2. That is, the smaller performance of CPU 202 is allocated to the virtual server 109 under the physical server 111 CPU of which has smaller performance.

The performance of CPUs of 0.9 GHz, 0.3 GHz and 0.6 GHz is respectively allocated to the virtual servers 1, 4, 7 included in the system group 1. The performance of CPUs of 0.75 GHz, 0.75 GHz, 0.5 GHz and 1.0 GHz is respectively allocated to the virtual servers 2, 3, 5, 8 included in the system group 2. The performance of CPUs of 0.4 GHz and 0.8 GHz is respectively allocated to the virtual servers 6, 8 included in the system group 3.

In this case, a total value of the performance of CPUs allocated to the virtual servers 1 to 3 under the physical server 1 is 2.4 GHz. A total value of the performance of CPUs allocated to the virtual servers 4 to 6 under the physical server 2 is 1.2 GHz. A total value of the performance of CPUs allocated to the virtual servers 7 to 9 under the physical server 3 is 2.4 GHz.

That is, a total value of the performance allocated to each virtual server under the physical server 2 and the physical server 3 is more than the performance of CPUs of the physical server 2 and the physical server 3. Then, the performance of CPUs of each physical server 1 to 3 is precedently allocated to the virtual servers 2, 3, 5, 8 included in the system group 2 having higher priority according to priority specified for the system groups.

Hereby, the performance of CPUs of 0.2 GHz and 0.4 GHz smaller than the required performance of CPUs is allocated to the virtual servers 6, 8 included in the system group 3 having the lowest priority. When the performance of CPUs allocated to the virtual server is smaller than the required performance of CPUs, the administrator is informed of it as warning. Therefore, 2.4 GHz is actually allocated while the performance of the physical server 1 is 3 GHz, 1 GHz is allocated while the performance of the physical server 2 is 1 GHz, and 2 GHz is allocated while the performance of the physical server 3 is 2 GHz.

A part of the performance of CPU in the physical server 1 is not allocated to the virtual servers 109. The unallocated performance (0.6 GHz) of CPU in the physical server 1 can be allocated to the virtual servers 6 and 9 to which the specified performance of CPUs is not allocated again. Another processing may be also executed using the unallocated performance of CPUs.

Hereby, even if the performance of CPUs 202 of the physical servers 111 is different, the performance of CPUs 202 can be efficiently allocated to the virtual servers 109.

FIG. 17 is a flowchart showing a process for allocating a functional group equally 1405 in the first embodiment of this invention.

In the process for allocating to the functional group equally, the performance of CPUs 202 is allocated to the virtual servers 109 included in the functional group as equally as possible. For example, when the system group is further configured by three functional groups of a Web server group, an application server group and a database server group, it is convenient for the administrator to manage that as the same performance of CPUs 202 as possible is allocated to virtual servers 109 included in the same functional group.

As steps 1701 to 1707 are the same as the steps 1501 to 1507 in FIG. 15, the description is omitted. As steps 1709 to 1712 are the same as the steps 1508 to 1511 in FIG. 15, the description is omitted.

The workload calculating module 1203 allocates the performance of CPUs 202 of each physical server based upon a rate allocated to each virtual server 109 determined in the step 1707 so that the performance allocated to the virtual servers 109 included in the functional group is the same as possible (the step 1708).

FIG. 18 is a flowchart showing a process for allocating to a functional group based upon a history 1406 in the first embodiment of this invention.

In the process for allocating to the functional group based upon the history, as a rate allocated to the virtual server 109 included in the functional group is determined based upon the virtual CPU utilization factor history data 902, more efficient allocation is executed.

As steps 1801 to 1807 are the same as the steps 1501 to 1507 in FIG. 15, the description is omitted. As steps 1809 to 1812 are the same as the steps 1508 to 1511 in FIG. 15, the description is omitted.

The workload calculating module 1203 calculates a rate allocated to the virtual server 109 included in a functional group based upon the allocation of each virtual server 109 determined in the step 1807 and allocates to each virtual server 109 again (the step 1808).

Specifically, the workload calculating module 1203 calculates a history of loads on CPUs 202 allocated to the functional group every functional group, referring to the virtual CPU utilization factor history data 902. For example, the workload calculating module 1203 multiplies the physical CPU allocated rate 1103 every time 1101 and the virtual CPU utilization factor 1104 every time 1101 of each virtual server 109 included in the same functional group, referring to the virtual CPU utilization factor history data 902. The workload calculating module 1203 calculates a mean value of the value acquired by multiplying them every virtual server 109. The workload calculating module 1203 totalizes the mean values of each virtual server 109 included in the same functional group and calculates the history of the loads on CPUs 202 allocated to the functional group. The workload calculating module 1203 calculates a rate allocated to the virtual server 109 every functional group based upon the history of the loads on CPUs 202 allocated to the functional group.

The workload calculating module 1203 can also calculate a more accurate load in environment in which a load on CPU 202 allocated to the virtual server dynamically varies because the module refers to both histories of an allocated rate actually acquired from the virtual server 109 of CPU 202 in the physical server and the virtual CPU utilization factor. As described above, in this embodiment, the management server 101 manages the virtual server 109 included in the respective groups and the physical server 111 corresponding to the virtual server 109 under control of a workload in a definition for making the system group and the functional group hierarchical. The management server 101 determines a rate allocated to the virtual server 109 based upon the total performance of CPUs 202 provided to the virtual server 111 included in each group when a workload is set.

In this embodiment, the control of a workload in the groups defined on two hierarchies has been described; however, this invention can be also applied to control of a workload in groups defined on one or more hierarchies based upon the above-mentioned concept.

FIG. 19 is a flowchart showing processing by the workload switching module 1202 in the first embodiment of this invention.

The workload switching module 1202 actually allocates CPU 202 in the physical server 111 to each virtual server 109 based upon the allocation calculated by the workload calculating module 1203. That is, the workload switching module 1202 switches a workload.

First, the workload switching module 1202 selects a system group having high priority (a step 1901).

Next, the workload switching module 1202 determines whether “switching time specification” is specified in the switching method 608 in the server group allocation setting command or not (a step 1902). The workload switching module 1202 executes a step 1903 when “switching time specification” is specified in the switching method 608 and executes a step 1904 when “switching time specification” is not specified in the switching method 608.

When “switching time specification” is specified in the switching method 608, the workload switching module 1202 gradually switches the current allocation allocated to the system group selected in the step 1901 to an allocation calculated by the workload calculating module 1203 in specified switching time (the step 1903).

For example, when the current allocation allocated to the system group is 60%, the allocation calculated by the workload calculating module 1203 is 20% and the specified switching time is ten minutes, the workload switching module 1202 switches the allocation from 60% to 20% in ten minutes. For example, the switching time is set in a range of 10 minutes to one hour. As for the switching time, the administrator can freely set it according to a characteristic of a program operated on the virtual server 109.

In the meantime, when “switching time specification” is not specified in the switching method 608, the workload switching module 1202 gradually switches to the allocation calculated by the workload calculating module 1203 so that a utilization factor of CPU 202 allocated to the virtual server 109 does not exceed a predetermined value (a step 1904). For example, the workload switching module 1202 gradually switches a workload so that a utilization factor of CPU does not exceed 30% when 30% is specified for the utilization factor.

Next, the workload switching module 1202 determines whether a workload of the system group selected in the step 1901 is switched or not (a step 1905). When the workload of the system group selected in the step 1901 is switched, the process proceeds to a step 1907 and when the workload of the system group selected in the step 1901 is not switched, the process proceeds to a step 1906.

When the workload of the system group selected in the step 1901 is not switched, that is, when the workload is not switched after predetermined time elapses, the workload switching module 1202 affiliates the virtual server 109 to another physical server 111 and prepares environment in which the workload is switched (the step 1906).

For example, the workload switching module 1202 selects the physical server 111 operated in a system group having a small utilization factor of CPUs in physical servers and having low priority out of the physical servers 111 included in the same system group. The workload switching module 1202 transfers environment in which the virtual server 109 a workload of which is not switched is operated into the selected physical server 111.

As elements such as CPU, a memory, a storage and a network configuring a system of virtual servers 109 are virtualized, they are separated from physical components provided to the physical server 111. Therefore, the virtual server 109 is located in environment more easily transferred to another physical server 111 than the physical server 111.

For example, as the virtual server 109 is transferred, the virtual server 109 can be also controlled only by changing an identifier of the network interface 204 and the number of the network interfaces 204 when the identifier of the network interface 204 and the number of the network interfaces 204 respectively specified for the virtual server 109 are changed. Therefore, as the virtual server 109 virtualizes and utilizes the configuration of the physical server 111 even if the configuration of the physical server 111 is changed, the same environment as that before transfer can be easily constructed by transferring the virtual server 109.

The workload switching module 1202 switches workloads by transferring the virtual server 109 having a large load on CPU 202 on another physical server 111 using a characteristic of the virtual server 109 while the workloads are switched.

Specifically, the workload switching module 1202 acquires environmental information such as an I/O device and memory capacity of the virtual server 109 to be transferred. The workload switching module 1202 constructs a new virtual server 109 on the physical server 111 to which the new virtual server is transferred based upon acquired environmental information. The workload switching module 1202 switches a workload of the newly constructed virtual server 109.

Hereby, in environment that a plurality of task systems are mixed in the plurality of physical servers 111, the resources of the physical servers 111 can be also effectively used.

Next, the workload switching module 1202 determines whether a workload is switched in all system groups or not (the step 1907). When a workload is switched in all the system groups, the process by the workload switching module 1202 is finished. In the meantime, when a workload is not switched in all the system groups, control is returned to the step 1901.

Hereby, as the performance of CPU 202 is gradually allocated to the virtual server 109, the performance of CPU 202 allocated to the virtual server 109 is never rapidly deteriorated. Therefore, even if the virtual server 109 processes a request while a workload of the virtual server 109 is being switched, the processing of the request by the virtual server 109 is never disenabled and the virtual server can process the request for fixed time.

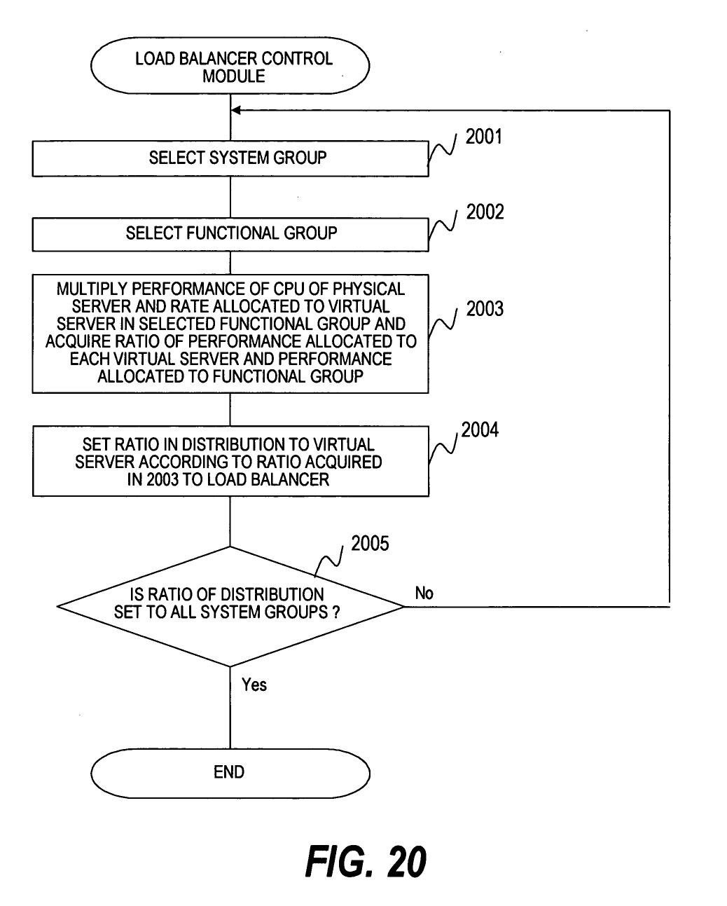

FIG. 20 is a flowchart showing a process by the load balancer control module 1204 in the first embodiment of this invention.

As the load balancer control module 1204 controls the load balancer 112 in a link with switching workloads, it can keep balance among loads in the computer system more precisely.

Normally, the load balancer 112 equally distributes a request to virtual servers 109 included in a plurality of Web server groups. However, as a result of switching workloads, performance of CPUs 202 allocated to each virtual server 109 included in the Web server groups operated in the virtual servers 109 is turned unbalanced. As a result, the performance in unit time of the virtual server 109 to which only small performance of CPU is allocated may be deteriorated. Then, the load balancer control module 1204 controls the load balancer 112 in a link with the result of switching workloads and can keep the performance of the computer system.

The load balancer control module 1204 selects a system group (a step 2001). Next, the load balancer control module 1204 selects a functional group in system group selected in the step 2001 (a step 2002). The load balancer control module 1204 multiplies the performance (an operating clock frequency) of CPU 202 in a physical server 111 in which a virtual server 109 included in the functional group selected in the step 2002 is operated by a rate of CPU 202 allocated to the virtual server 109 (a step 2003). Hereby, ratio of the performance of CPU 202 allocated to each virtual server 109 and the performance of CPU 202 allocated to the functional group selected in the step 2002 is calculated.

Next, the load balancer control module 1204 sets ratio of distribution for the load balancer 112 to distribute a request from the client terminal among the virtual servers 109 based upon the ratio acquired in the step 2003 (a step 2004).

It is determined whether the rate of distribution is set to all system groups or not (a step 2005). When the ratio of distribution is set to all the system groups, the process by the load balancer control module 1204 is finished. When the ratio of distribution is not set to all the system groups, control is returned to the step 2001.

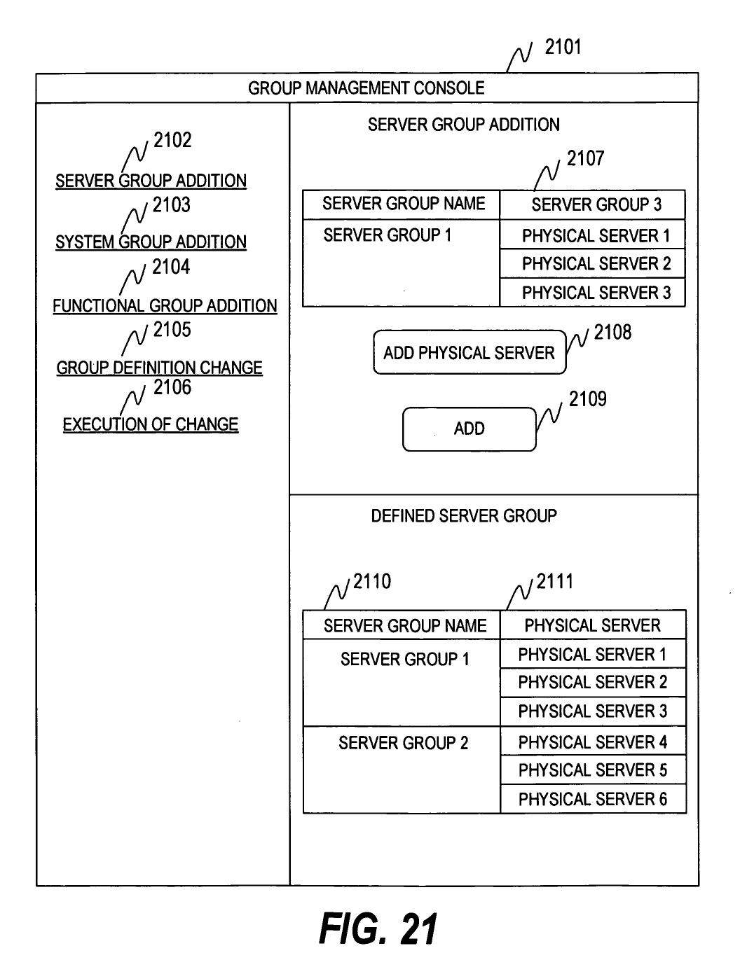

FIG. 21 shows a screen displayed when a server group in the first embodiment of this invention is added.

A group management console 2101 includes server group addition 2102, system group addition 2103, functional group addition 2104, a group definition change 2105 and the execution of the change 2106.

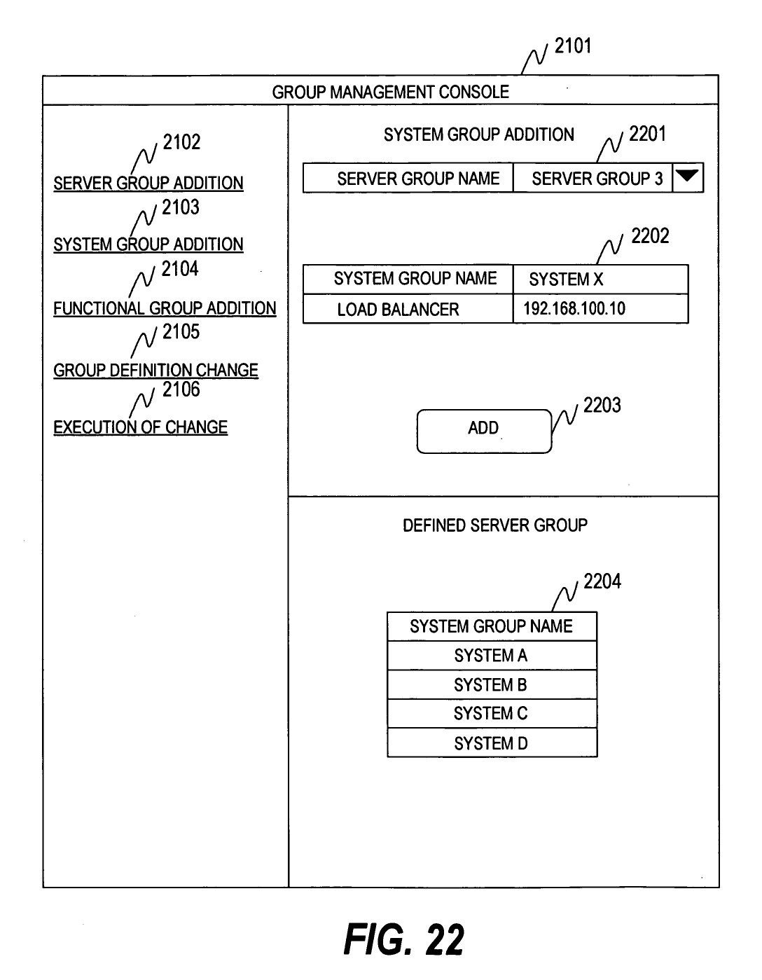

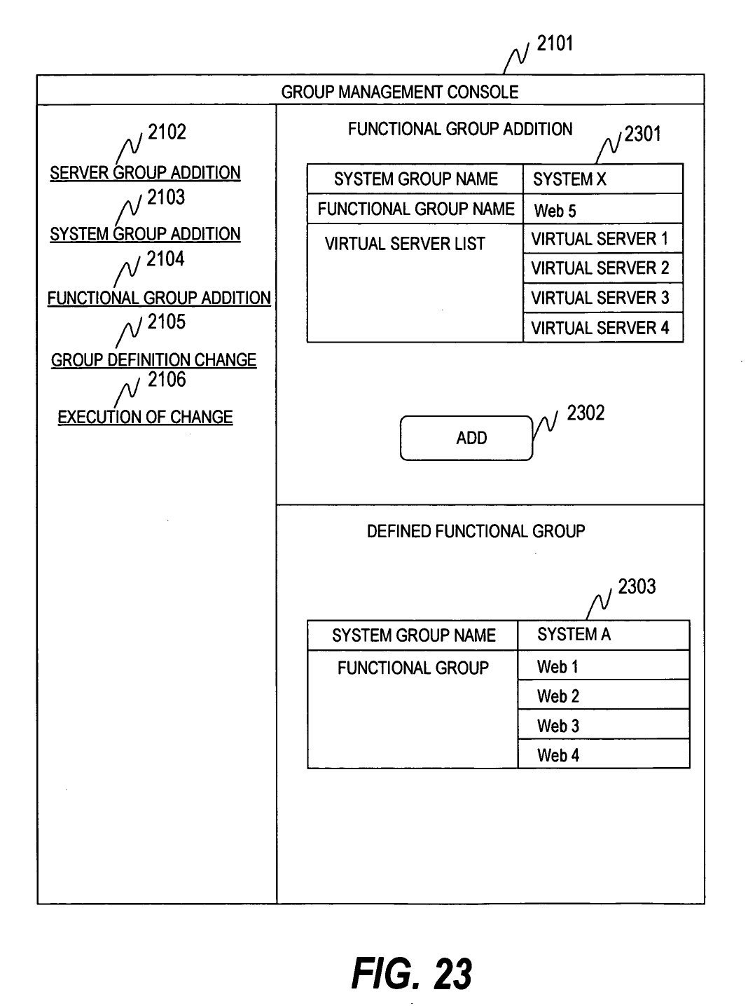

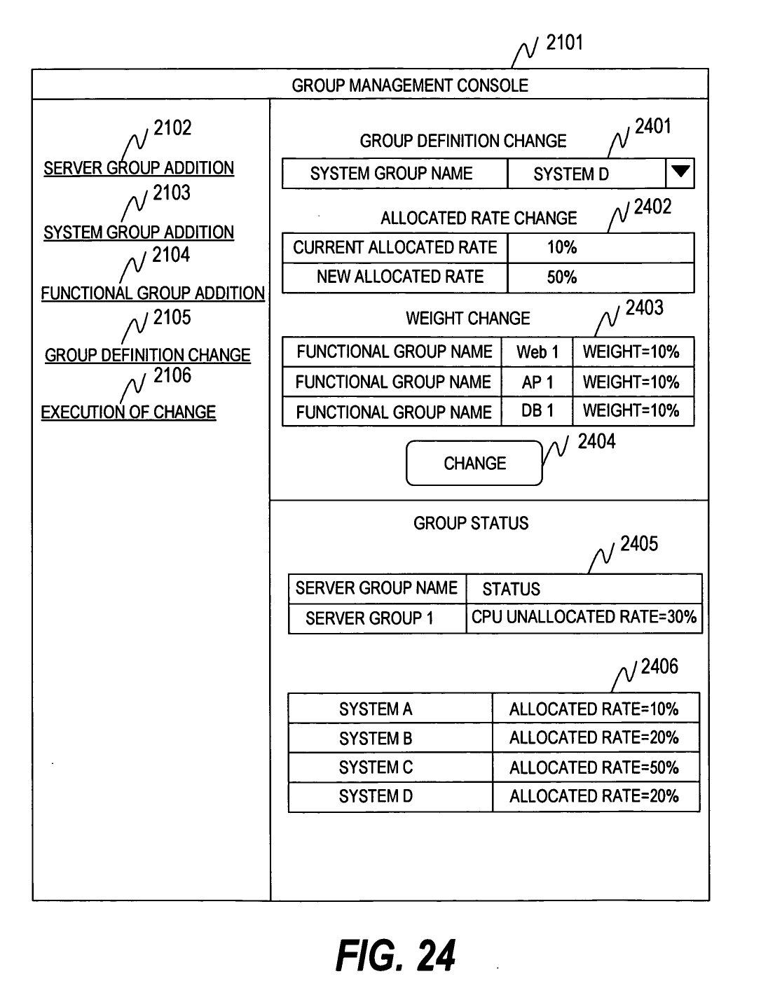

When the administrator selects the server group addition 2102, the screen shown in FIG. 21 is displayed and the administrator can add a server group. When the administrator selects the system group addition 2103, a screen shown in FIG. 22 is displayed and the administrator can add a system group. When the administrator selects the functional group addition 2104, a screen shown in FIG. 23 is displayed and the administrator can add a functional group. When the administrator selects the group definition change 2105, a screen shown in FIG. 24 is displayed and the administrator can change the definition of the group (e.g., allocation of CPU 202 allocated to the system group). When the definition of the group is changed by the administrator, a screen shown in FIG. 25 is displayed to ascertain the administrator about whether a change of the definition of the group is to be executed or not.

The administrator can define the groups hierarchically by operating the server group addition 2102, the system group addition 2103 and the functional group addition 2104.

FIG. 21 shows the screen displayed on the console when the administrator selects the server group addition 2101. The administrator inputs a server group name and a physical server 111 included in the corresponding server group on an input area 2107. When the administrator presses an addition button 2109, input contents are written to the group definition table.

Currently defined server group names 2110 and physical servers 2111 included in the server group are displayed in a defined server group display area. The administrator can refer to the currently defined server group names 2110 and the physical servers 2111 included in the server group in the defined server group display area.

The unallocated performance of CPU 202 in each physical server 111 may be also displayed based upon the physical CPU allocated rate 1103 acquired by the history management program 105 in the defined server group display area.

Hereby, the administrator can set the server group in consideration of a situation of the current allocation of CPU 202 in each physical server 111.

FIG. 22 shows a screen displayed when a system group is added in the first embodiment of this invention.

FIG. 22 shows the screen displayed on the console when the administrator selects the system group addition 2103. The administrator selects a server group to which a system group to be newly added belongs in an input area 2201. The administrator inputs a system group name to be added in an input area 2202. When the administrator presses an addition button 2203, input contents are written to the group definition table 107.

The administrator can also define an address of the load balancer 102 by inputting the address of the load balancer 102 in the input area 2202 if necessary.

Currently defined system group names 2204 are displayed in a defined system group display area. The administrator can refer to the currently defined system group names 2204 in the defined system group display area.

FIG. 23 shows a screen displayed when a functional group is added in the first embodiment of this invention.

FIG. 23 shows the screen displayed on the console when the administrator selects the functional group addition 2103. The administrator inputs a system group name to which a functional group to be newly added belongs, a functional group name to be added and virtual server names included in the functional group in an input area 2301.

When the administrator presses an addition button 2302, input contents are written to the group definition table 107.

Currently defined functional group names 2303 are displayed in a defined functional group display area. The administrator can refer to the currently defined functional group names 2303 in the defined functional group display area.

FIG. 24 shows a screen displayed when the definition of a group is changed in the first embodiment of this invention.

FIG. 24 shows the screen displayed on the console when the administrator selects the group definition change 2105. The administrator selects a changed system group name in a group definition change input area 2401. In addition, the administrator inputs a new allocated rate which is a rate of CPU 202 allocated to a new system group in an allocated rate change input area 2402. In the allocated rate change input area 2402, a rate of CPU 202 allocated to the current system group is displayed. The administrator inputs weight which is a rate of CPU 202 allocated to a functional group every functional group in a weight change input area 2403.

When the administrator presses an addition button 2404, input contents are written to the group definition table 107.

In a server group status area 2405 in a group status display area, a currently defined server group name and a value represented by percentage of the performance of CPU 202 not allocated to the server group yet are displayed. In a system group status area 2406 in the group status display area, allocations allocated to system groups are displayed. The administrator can refer to the current status of the server group and each allocation of the current system groups in the group status display area.

The administrator can input a rate allocated to the system group in consideration of the performance of CPU 202 not allocated to the server group yet.

FIG. 25 shows a screen displayed when the group definition change is executed in the first embodiment of this invention.

FIG. 25 shows the screen for ascertaining the administrator about whether the group definition change is executed or not when the definition of the group is changed by the administrator on the screen shown in FIG. 24.

When the definition of the group is changed according to the definition of the group changed by the administrator, the administrator presses an execution button 2501.

When the definition of the group is changed, the result of the execution is displayed as execution status 2502. In an execution status area 2502, it is displayed that a specified allocation cannot be applied to the virtual server 109 and the allocation is normally finished.

When it is informed the administrator that the allocation is impossible in the step 1509, the step 1710 and the step 1810, the screen shown in FIG. 25 is also displayed.

In this case, it is displayed that an allocation specified in the execution status 2502 cannot be applied to the virtual server 109.

As the administrator sets a rate allocated to a system group based upon the result, the administrator can perform further optimum workload management.

### Second Embodiment

In the first embodiment of this invention, a rate of CPU 202 allocated to the virtual server 109 is defined by the performance of CPU 202. In a second embodiment of this invention, a rate of CPU 202 allocated to a virtual server 109 is defined by the number of cores of CPU 202.

CPU 202 in this embodiment comprises a plurality of cores. Each core can execute a program simultaneously.

CPU 202 in the first embodiment of this invention comprises a single core. The example that the single core is shared by the plurality of virtual servers 109 is described. However, in the case of CPU 202 having a plurality of cores, allocation to a virtual server in units of core is independent and efficient.

The same reference numeral is allocated to the same component as that in the first embodiment and the description is omitted.

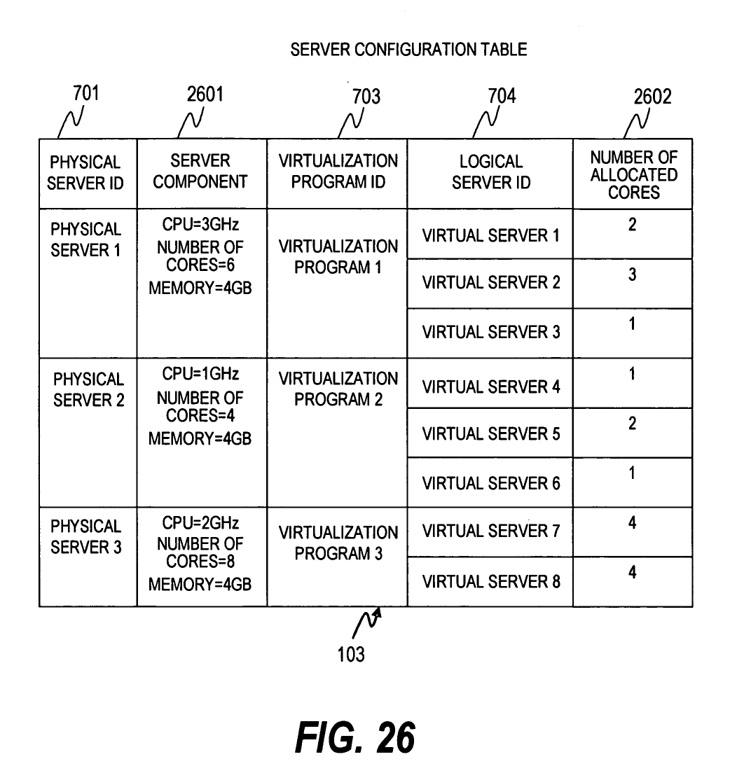

FIG. 26 shows a server configuration table 103 in the second embodiment of this invention.

The server configuration table 103 includes physical server ID, a server component 2601, virtualization program ID 703, logical server ID 704 and the number of allocated cores 2602.

In a field of the server component 2601, an operating clock frequency of CPU 202 of a physical server 111, the number of cores and the capacity of a memory are registered. The number of cores of CPU 202 is an object which a workload management program 102 manages.

In a field of the number of allocated cores 2602, the number of cores of CPU 202 which is a unit allocated to the virtual server is registered.

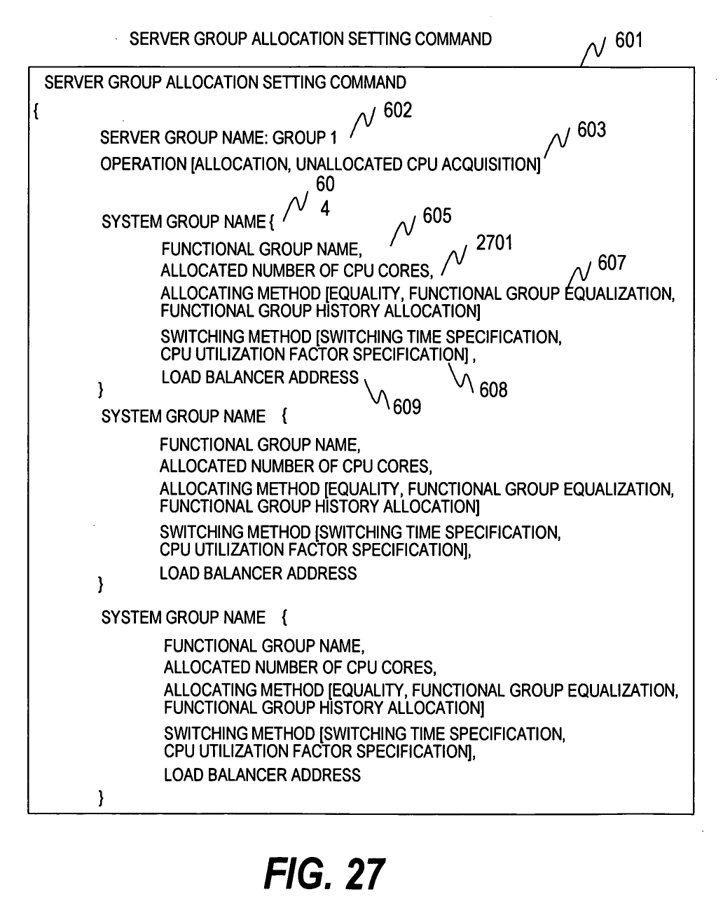

FIG. 27 shows a server group allocation setting command.

The server group allocation setting command in the second embodiment is different from that in the first embodiment in that an allocated rate of CPU 606 is changed to the number of allocated cores of CPU 2701. In this embodiment, CPU 202 is allocated to the virtual server 109 in units of core.

In the first embodiment of this invention, the workload calculating module 1203 calculates a rate allocated to the virtual server 109 using the operating clock frequency (GHz) of CPU 202 as a unit, however, in the second embodiment of this invention, a workload calculating module 1203 calculates a rate allocated to the virtual server 109 based upon the number of cores of CPU 202 and an operating clock frequency of the core of CPU 202 as in the first embodiment of this invention.

While the present invention has been described in detail and pictorially in the accompanying drawings, the present invention is not limited to such detail but covers various obvious modifications and equivalent arrangements, which fall within the purview of the appended claims.

What is claimed is:

1. A computer management method in a computer system having a plurality of physical computers each of which has a processor for operation, a memory coupled to the processor and an interface coupled to the processor, a plurality of virtual computers operated in the physical computer and a management computer coupled to the physical computer via a network and having a processor for operation, a memory coupled to the processor and an interface coupled to the processor,
wherein the management computer holds information for relating the physical computer and the virtual computer operated in the physical computer and information for managing one or more virtual computers as a group, and
wherein the management method comprising:
receiving designation of performance allocated every group;
acquiring the performance of the physical computers; and
allocating the performance of the group whose performance is designated to the virtual computers included in the group based upon the acquired performance of the physical computers.

2. A computer management method according to claim 1, further comprising the steps of:
allocating the performance of the physical computers to a group having higher priority specified by an administrator in order;
informing the administrator not to be able to allocate the designated performance when there is a group to which the designated performance cannot be allocated; and
allocating unallocated performance to the group to which the performance cannot be allocated.

3. A computer management method according to claim 2, further comprising the step of, sending the administrator information of the acquired performance of the physical computers.

4. A computer management method according to claim 1, wherein in the performance allocating step, the smaller performance is allocated to the virtual computer operated in the physical computer having only small performance based on the acquired performance of the physical computers.

5. A computer management method according to claim 1,
wherein the computer system further has a client computer that transmits a request and a load balancer that distributes the request among the virtual computers, and
wherein the load balancer distributes the request from the client computer according to performance allocated to virtual computers included in the group.

6. A computer management method according to claim 1,
wherein the group further includes a plurality of subgroups, and
wherein in the performance allocating step, the performance is allocated to virtual computers included in the subgroup based upon allocated performance designated every subgroup.

7. A computer management method according to claim 1, further comprising the steps of,
determining time until the switching of performance allocated to the virtual computer is completed, and
switching gradually the performance allocated to the virtual computer in the determined time.

8. A computer management method according to claim 1, further comprising the steps of,
setting an upper limit of a load on a virtual computer the performance allocated to which is switched, and
switching the performance allocated to the virtual computer in a range that does not exceed the set upper limit of the load on the virtual computer.

9. A computer management method according to claim 1, further comprising the steps of,
allocating the performance of the physical computer to a group having higher priority specified by an administrator in order,
moving, when a load on the virtual computer is larger than a predetermined threshold, the virtual computer the load of which is larger than the predetermined threshold to another physical computer included in a group having low priority, and
allocating the performance of another physical computer to the moved virtual computer.

10. A computer system having a plurality of physical computers each of which has a processor for operation, a memory coupled to the processor and an interface coupled to the processor, a plurality of virtual computers operated in the physical computer and a management computer coupled to the physical computer via a network and having a processor for operation, a memory coupled to the processor and an interface coupled to the processor,
wherein the management computer:
holds information for relating the physical computer and the virtual computer operated in the physical computer and information for managing one or more virtual computers as a group;
receives designation of performance allocated every group is accepted;
acquires the performance of the physical computers; and
allocates the performance of the group whose performance is designated to virtual computers included in the group based upon the acquired performance of the physical computers.

11. A machine-readable medium, containing at least one sequence of instructions, for allocating the performance of a physical computer to virtual computers in a computer system,
wherein the computer system has a plurality of physical computers each of which has a processor for operation, a memory coupled to the processor and an interface coupled to the processor, a plurality of virtual computers operated in the physical computer and a management computer coupled to the physical computer via a network and having a processor for operation, a memory coupled to the processor and an interface coupled to the processor,
wherein the management computer holds information for relating the physical computer and the virtual computer operated in the physical computer and information for managing one or the plurality of virtual computers as a group, and
wherein the instructions that, when executed, causes a management computer to:
receive designation of performance allocated every group;
acquire the performance of the physical computers; and
allocate the performance of the group whose performance is designated to virtual computers included in the group based upon the acquired performance of the physical computers.
